(19) United States
(12) Patent Application Publication
(10) Pub. No.: US 2008/0293033 A1
(43) Pub. Date: Nov. 27, 2008

(54) IDENTITY MANAGEMENT SYSTEM, INCLUDING MULTI-STAGE, MULTI-PHASE, MULTI-PERIOD AND/OR MULTI-EPISODE PROCEDURE FOR IDENTIFYING AND/OR AUTHENTICATING TEST EXAMINATION CANDIDATES AND/OR INDIVIDUALS

(76) Inventors: Anthony R. Scicchitano, Lancaster, PA (US); Roger D. Meade, Baltimore, MD (US); Jason Valentine Young, Baltimore, MD (US)

Correspondence Address: WILMERHALE/NEW YORK, 399 PARK AVENUE, NEW YORK, NY, 10022, US

(21) Appl. No.: 12/057,249

(22) Filed: Mar. 27, 2008

Related U.S. Application Data
(60) Provisional application No. 60/920,464, filed on Mar. 28, 2007.

(51) Int. Cl. G09B 3/00

(52) U.S. Cl. 434/350

(57) ABSTRACT

A method and/or system for identity management and authentication of examination candidates by, for example, capturing biometric data and identification information from an examination candidate and storing the data and information in a database. The method and/or system includes, for example, capturing biometric data from an individual at a later time for comparison with data stored in the database, and which allows authentication of the individual after determining that the biometric data matches the previously stored data and the individual matches the previously stored information.

### CROSS REFERENCE TO RELATED APPLICATIONS

This application is related to and claims the priority of U.S. Provisional Application Ser. No. 60/920464, filed Mar. 28, 2007 and incorporated herein by reference.

### FIELD OF THE INVENTION

The present invention generally relates to the field of computer-based testing, and in particular, a system and method for tracking examination candidates through stages, phases, and periods of an examination as well as from examination to examination.

### BACKGROUND OF THE INVENTION

Many schools and universities require standardized test results as part of a student's admissions application. Examples of these standardized tests are the Scholastic Aptitude Test (SAT), Law School Admissions Test (LSAT), Medical College Admissions Test (MCAT), Graduate Record Examination (GRE) as well as many others. The preparation of these examinations requires numerous hours and generally reflects copyrighted material owned by the examination providers. As such, much time and effort is spent ensuring the integrity of the examination.

Test takers must be properly registered to guarantee that only those persons who are qualified are registered to take the examination. It is also important to ensure that only persons who are registered are allowed to take the examination. The integrity of any test is damaged, of course, if tests are taken by persons other than those who are properly registered. It is also important that the test be properly proctored to ensure that cheating does not take place. Lastly, the test question information must be secure from theft, unauthorized access and alteration. All of the above security measures require significant expense and manpower.

As the number of students applying to schools and universities continues to grow, the scores on the standardized test each school requires for admission has been also been continuing to rise. Consequently, an industry has grown to prepare examination takers for the examinations with the hope of improving their test scores, and therefore, chances of admission to the school or university of their choice.

Along with the burgeoning test preparation industry, a growing number of examination takers are seeking to improve their test scores and the test scores of others via illicit means. The content of standardized tests is generally highly protected, and as such, examination takers are prevented from copying or removing the test material from the examination testing location. To circumvent these protections, a trend has developed of “professional” examination takers sitting for examinations with the sole purpose of memorizing testing material for removal from the examination testing sites. These professional test takers may be present at each offering of an examination, and may use fake identification or hide among the general population of examination test takers to avoid detection. The material removed from the testing location can later be used to help legitimate examination takers prepare for exams by familiarizing them with actual test questions and answer choices. As such, the examinations become an ineffective test of the examination takers' knowledge. We have determined therefore that there is a need to protect the test material from theft by these professional test takers.

Another method of illicitly improving test scores exists such that an individual may have an examination test taker sit for the examination in the individual's place, and thereby have the examination test taker's results attributed to the individual. The examination test taker may present the individual's identification information as their own to have their testing results attributed to the individual. As well, the examination test taker may present fake identification information bearing the picture of the examination test taker but other identification information, such as the name and address, of the individual. We have further determined that there is a need to ensure that the examination takers' results are attributed to the examination test takers themselves, and not another individual.

As well, we have determined that there exists a need to properly monitor the administration of the examinations themselves. Generally, proctors are assigned to examination testing locations to monitor the examination takers, providing testing materials, as well as keep examination times. There exists a need to ensure that examination proctors are properly monitoring examination takers at regular intervals and properly administering the examination within the time constraints determined by the examination providers.

Additionally, there exists a need to monitor and control test center administrators and test center owners to ensure that administrators and owners are not permitted to allow cheating to occur during examinations. Where administrators also offer a series of preparation or certification courses that each culminate in an exam that must be passed before moving to the next level of certification, a conflict of interest exists for the administrator to allow cheating. As such, there exists a need to ensure that test center administrators and owners that have been found to allow cheating are not permitted to own or administrate other testing centers.

Further, there exists a need to monitor the activities of examination test takers during the examinations. Examination takers may be allowed to leave the testing location for regularly scheduled breaks as well as restroom breaks. It is possible that examination takers may attempt to cheat by receiving help during breaks or by having an individual replace the examination taker to complete the remainder of an examination after a break. As such, there exists a need to monitor each examination taker to ensure that breaks in the examination are not taken too frequently and to ensure that the examination taker remains consistent throughout the entire examination.

There also exists a need to ensure that a candidate is the same individual through each step of their career. As individuals become more mobile and national and international travel becomes more common, examination takers have varying degrees of identification information. Schools and universities are in need of means to ensure that the student making an application for admission using standardized test results is the individual that sat for the examination. There also exists a need to ensure that the candidate that sat for the standardized test for admission to the school or university is the same student that graduated from the school or university and is now sitting for another standardized examination.

Several systems and methods form the basis for the present application. For example, U.S. Pat. No. 5,915,973, sharing the same assignee as the present application and incorporated in its entirety by reference, describes a system for controlling the administration of remotely proctored, secure examinations at a remote test station and a method for administering examinations. The system contains a central station containing a database that stores both test questions as well as verified biometric data for comparison with biometric data captured at a testing location and a biometric measuring device at the testing location for inputting biometric data to a data processor. The system also includes a display at the testing location for displaying the testing questions stored in the database, an input for inputting testing response data, a recorder for recording proctoring data of a testing event and a communications link for communicating with a central station containing the database. The biometric data from the test taker can be compared with the verified biometric data stored in the database either before or after the testing event.

FIG. 1 depicts a flow chart for prior art method for examination candidate registration. Upon arrival, an examination candidate presents identification in step 40 and which is recorded in step 41. Other qualification information is then requested in step 42 and recorded in step 43. Depending on the type of test for which the examination candidate wishes to be registered, as input in step 44, it is determined whether the examination candidate is qualified in step 47. If the test is determined to be an eligibility type test at step 45, the examination candidate's data is communicated to a central station at step 46 before performing step 47. If the examination candidate is not qualified, the registration is stopped at step 48. If the test is not an eligibility test, then the processor of the registration site is instructed to qualify the examination candidate of step 47.

If the examination candidate is qualified, the input of biometric data is requested in step 49. After the input of biometric data, payment is collected in steps 50, 51 and 52. If payment is by credit card, approval needs to be obtained in step 51. If payment is by cash, then cash or a check is collected in step 52. If the payment collection is confirmed at step 53, then a testing event is scheduled at step 54, and the biometric, and other personal data of the examination candidate is sent to the central station at step 55. Steps 54 and 55 can also take place in reverse order, if desired. The scheduling step 54 will also typically include the input of data such as the preferred time and place at which the examination candidate desires to take the test. If the test is scheduled to take place directly after registration at step 56, then the examination candidate goes directly to step 62 of the testing event shown in FIG. 2. If the test is taken at a later date, a registration card is printed using printer 28, or registration number issued at step 57 and the registration completed at step 58. The registration card, or number can be used in the check-in process at the start of the testing event illustrated in FIG. 3. If payment is not collected at step 53, the registration is ended at step 48.

FIG. 2 depicts a prior art test taking process in which the testing event is verified during the event at a testing kiosk. The testing process begins, upon arrival of the examination candidate at the remote testing station, with a request of the examination candidate to present a registration card printed during the registration process, or enter a registration number during step 60. The request for the registration card or registration number stated on the card is made at a display outside of a kiosk in order to open the door. For this purpose, a display and a card reader are provided outside the kiosk. Otherwise, the prompt is given on display of the remote testing site and card information may either be entered by the examination candidate with input, or a special input, such as accord reader, may be provided for that purpose.

If the card is determined to be valid at step 61, and the examination candidate is verified as a valid examination candidate, then the recording of audio/visual proctoring data begins at step 62, and the examination candidate is asked to enter biometric data at step 63. For example, the examination candidate is asked to face the video camera for the taking of a still picture or the taker is asked to place his hand or finger in suitable recording device.

If there is an invalidating event while the biometric data is being measured (step 64) then the testing event is invalidated and the test stopped. An invalidating event could be, for example, the presence of two persons in the remote testing station, or an attempt to improperly or fraudulently enter biometric data. Typically, the types of occurrences or data which would constitute invalidating events would vary depending on the particular test and level of security required. The proctoring data may include more than audio/visual data, such as a signal from an electronic door lock, etc., in which case, an invalidating event could be an unlocked or opened door signal. If there is no invalidating event, then the biometric data is communicated to a central station in step 65 and compared at step 66 with verified biometric data stored in the storage device or database.

If the communicated examination candidate biometric data matches the verified biometric data corresponding to the proper examination candidate (step 67), then test question data is communicated to remote test site (step 69). Steps 70, 71 and 73 represent the entry of test response data by the examination candidate in response to question data displayed in display 32. If at any point during the entry of test response data an invalidating event occurs (step 72), as determined by analysis of the proctoring data, then the testing event is stopped and/or invalidated (step 68). As disclosed above, invalidating events would include the opening of the kiosk door by the applicant, unauthorized use of notes or reference materials, or unauthorized communication between the examination candidate and someone outside the kiosk.

After all questions have been answered (step 73) the examination candidate is given the option of reviewing the questions (step 74), or completing the test (step 76). In step 77 a unique identifier is assigned to the testing event for use in coordinating test response data and proctoring data for the testing event. Thereafter, the test response data is communicated to the central station at step 78.

A record of the testing event is then printed for the examination candidate at step 79. In one embodiment, because the proctoring data is used to validate the testing event during the event, a verified test result can be given to the examination candidate at step 79.

The prior art method also contemplates a condition where the proctoring data is analyzed and the testing event validated after the event, in which case the examination candidate is given only a record of having completed the testing event at step 79, and is given a validated test result subsequent to the end of the test at step 80, such as by the printing of an Official Score Report Form.

FIG. 3 is a flow diagram of the prior art central site activity during registration and testing in FIGS. 1 and 2 where the examination candidate is permitted to address queries to a central station at step and receive answers. The central station then receives the test response data at step 78, and prints a record. As discussed above, the record may also be printed at the remote test site if the test is validated during the event.

As another example, US. Pat. No. 7,080,303, sharing the same assignee as the present application and incorporated in its entirety by reference, describes a method and system for computer based testing using plug-ins to expand the functionality of a test driver. The system includes a test driver containing executable code to control the delivery of a test to an examinee through the progression, scoring, timing, printing and results reporting. The system also contains a resource file in communication with the test driver that stores information related to the functions of the test driver and an expansion module that also contains information related to the functions of the test driver and which allows the functionality of the test driver to be modified without necessitating modification of the test drive executable code.

FIG. 4 shows an overview of the software architecture for the computer-based test delivery system of a prior art system, denoted generally by reference numeral 100. Test driver 110 is responsible for controlling all aspects of the computer-based test. Test driver 110 identifies examination candidates scheduled to take the computer-based test and identifies and creates the appropriate test. Test driver 110 then presents all of the test components to examination candidates using a display device (not shown), such as a computer monitor, and enables examination candidates to enter responses to test questions through the use of an input device (not shown), such as a keyboard, a mouse, etc. Test driver 110 also monitors the security of the test. For example, test driver 110 can prevent access to the Internet and can validate examination candidates, although, these functions are performed by the test center administration system. Test driver 110 also monitors the timing of the test, providing relevant warnings to examination candidate regarding the elapsed time of the test and the time remaining for a particular section of the test or for the entire test. Test driver 110 is also responsible for scoring the test, once the test is completed or while the test is in progress, and for reporting the results of the test by physical printout using printer 182 or in a file format using candidate exam results file 180. If the test is interrupted while in progress, for example, due to a power failure, test driver 110 restarts the test, at the point at which the test was interrupted, as will be described subsequently in more detail. Finally, if the test is left incomplete, test driver 110 cleans up the incomplete test. An incomplete test will have an exam instance file in the examination candidate's directory but will not have created a results file. A results file is created even though generally the candidate will fail. The number of items delivered to the examination candidate is recorded in the results file. Test driver 110 picks up where the event was interrupted and invisibly deliveries the rest of the units of the test.

A test specification is authored by a test publisher according to the specifications of the client and stored in exam source files 130. Exam source files 130 include data files 132, XXL files 134, multimedia files 136, and hypertext markup language (“HTML”) files 138. XXL files 134 include the test specification, which contains the client's requirements for the test, a bank of test items or questions, templates that determine the physical appearance of the test, plug-ins, and any additional data necessary to implement the test. Additional data is also stored in data files 132. For example an adaptive selection plug-in may need a, b & c theta values. These values are stored in a binary file created by a statistical package.

HTML files 130 include, for example, any visual components of the test, such as the appearance of test items or questions, the appearance of presentations on the display device, the appearance of any client specified customizations, and/or the appearance of score reports. HTML files 130 also include script, for example, VBscript and Jscript, or Java script. HTML files 130 are authored using Microsoft's FrontPage 2000. FrontPage 2000 is also used to manage the source files in a hierarchy that is chosen by the test publisher. Multimedia files 136 include, for example, any images (jpg, .gif, etc.) and/or sound files (.mp3, .wav, .au, etc.) that are used during the test.

XXL compiler 140 retrieves XXL files 134 from exam source files 130 using interface 190 and compiles the XXL test content stored in XXL files 134. XXL compiler 140 stores the compiled test files in exam resource file 120. Exam source files 130 do not contain XXL files 134 and contains, for example, only multi-media files. XXL compiler 140 is merely a test packager that writes the data directly to exam resource file 120 without modification or validation. The data appears in a stream under the “data” branch of exam resource file 120. The name of the stream is specified by the test author.

XXL files 134 also include XXL language that defines plug-ins 150, in which case, plug-ins 150 assist XXL compiler 140 in compiling XXL files 134. Test driver 110 supports, for example, nine different types of plug-ins 150, including, for example: display plug-in 152; helm plug-in 154; item plug-in 156; timer plug-in 158; selection plug-in 160; navigation plug-in 162; scoring plug-in 164; results plug-in 166; and report plug-in 168. Plug-ins 150, which are also included in XXL files 134, are the first XML files compiled into exam resource file 120.

Plug-ins 150 allow a test designer to customize the behavior of test driver 110 and are divided into two types, for example: visible plug-ins and invisible plug-ins. The visible plug-ins, which include display plug-in 152, helm plug-in 154, and item plug-in 156, enable the test driver to control what is presented visually to an examination candidate on the display device. The invisible plug-ins, which include timer plug-in 158, selection plug-in 160, navigation plug-in 162, scoring plug-in 164, results plug-in 166, and report plug-in 168, enable the test driver to control more functional aspects of the test. Plug-ins 150 are used to validate data stored in exam source files 130 that is to be used by one of plug-ins 150 during delivery of the test to the examination candidate, as is described below in greater detail. Plug-ins 150 are component object model (“COM”) objects, as described below. Plug-ins 150, may also utilize Java implementation. Plug-ins 150 are written using Microsoft Visual C++ or Visual Basic 6.0 or any fully COM enabled language. Plug-ins 150 may be in or out-of-process, and, therefore, can exist as executable (“.EXE”) files or as dynamic link library (“.DLL”) files.

An application or component that uses objects provided by another component is called a client. Components are characterized by their location relative to clients. An out-of process component is an .exe file that runs in its own process, with its own thread of execution. Communication between a client and an out-of-process component is therefore called cross-process or out-of-process communication.

An in-process component, such as a .dll or .ocx file, runs in the same process as the client. It provides the fastest way of accessing objects, because property and method calls don't have to be marshaled across process boundaries. However, an in-process component must use the client's thread of execution.

Exam resource file 120 receives the compiled test content from XXL compiler 140 and plug-ins 150, if applicable, and stores the compiled test content in an object-linking and embedding (“OLE”) structured storage format, called POLESS, which is described in greater detail below. Other storage formats may optionally be used. OLE allows different objects to write information into the same file, for example, embedding an Excel spreadsheet inside a Word document. OLE supports two types of structures, embedding and linking. In OLE embedding, the Word document of the example is a container application and the Excel spreadsheet is an embedded object. The container application contains a copy of the embedded object, and changes made to the embedded object affect only the container application. In OLE linking, the Word document of the example is the container application and the Excel spreadsheet is a linked object. The container application contains a pointer to the linked object and any changes made to the linked object change the original linked object. Any other applications that link to the linked object are also updated. POLESS supports structured storage such that only one change made to an object stored in exam resource file 120 is globally effective. Test driver 110 comprises Active Document container application 112 for the visible plug-ins, display plug-in 152, helm plug-in 154, and item plug-in 156, which function as embedded objects.

Both XXL compiler 140 and plug-ins 150 are involved in storing the compiled test content into exam resource file 120, if any of plug-ins 150 are being used. Exam resource file 120 comprises, for example, a hierarchical storage structure. Other storage structures may optionally be used. XXL compiler 140 determines to which storage location a specific segment of the compiled test content is to be stored. However, if any of plug-ins 150 are used to validate the portion of any of the data from exam source files 130, then the plug-ins 150 store the data directly to the exam resource file, based upon directions from XXL compiler 140. XXL compiler uses IPersistResource interface 192, co-located with I-Plug-in interface 167 in FIG. 4, to control the persistence of the data to exam resource file 120. XXL compiler 140 and plug-ins 150 write the data to exam resource file 120 using POLESS interfaces 191.

FIG. 5 illustrates a prior art method of restarting a test after interruption in greater detail. In a test restart method, test driver 110 is started at step 1537. Test driver 110 determines whether the test has already started, step 1539. If the test delivery has not already started, plug-ins 150 reload validated test specification and content from exam resource file 120, at step 1543. If the test has already started, plug-ins retrieve examination information from exam instance file 120, at step 1541. Plug-ins 150 then reload the validated test specification and content from exam resource file 120, at step 1543. Test driver 110 then delivers the exam to the examination candidate, at step 1545.

FIG. 6 illustrates the life cycle of plug-in 150 from test production to test delivery, denoted generally by reference numeral 1420 according to the prior art system. Dashed vertical line 1422 divides the plug-in life cycle 1420 into a test production cycle, to the left of dashed vertical line 1422, and a test delivery cycle, to the right of dashed vertical line 1422. The test production cycle occurs only occasionally when new plug-ins 150 are developed to satisfy the requirements of a client. The test delivery cycle occurs whenever the test is delivered to the examination candidate, for example, daily.

Exam source files 130, of which data files 132 and XXL files 134 are shown, contain every aspect of the test as written by the test publisher. In step I, XXL compiler 140 reads from XXL files 134 and interprets instructions that call for the use of a plug-in 150. Plug-in 150 is identified in the XXL test definition language by both a name and a program identification (“prog ID”). When XXL compiler receives the prog ID from XXL files 134, XXL compiler knows that a plug-in 150 is required to complete the compilation of exam source files 130.

Step II contains two steps, indicated as step IIa and IIb. In step IIa, XXL compiler 140 creates the appropriate storage element in exam resource file 120 using POLESS object 300. The storage element type is determined based on the type of IPersistResource interface 192 that plug-in 150 implements, for example: IPersistResourceStream interface 192a; IPersistResourceSet interface 192b; or IPersistResourceStore interface 192c. XXL compiler 140 then calls IPersistResource*::Save( ) call 1434 for the appropriate IPersistResource interface. Plug-in 150 saves the compiled information from exam source files 130 to exam resource file 120 through the POLESS object 300 passed by XXL compiler 140. In step IIb, XXL compiler 140 instructs plug-in 150 to unload, or flush, its content using Unload( ) call 1436. As stated previously, steps I, IIa, and IIb are repeated until all of exam source files 130 is compiled.

### SUMMARY OF THE INVENTION

It is one feature and advantage of the present invention to enable the tracking of an examination candidate during an examination, during breaks from an examination and between examinations.

It is another optional feature and advantage of the present invention to enable the tracking of test center administrators during an examination.

It is another optional feature and advantage of the present invention to enable the authentication of individuals at an event, such as, for example, an examination.

These and other features and advantages of the present invention are achieved by capturing biometric data and identification information from an individual for storage in a database. During an examination biometric data is captured at regular intervals, such as, for example, periodically during the examination, during breaks from the examination and at the termination of the examination. The identity of the examination candidate can be reconfirmed each time biometric data is captured by comparison with previously captured biometric data.

In another embodiment, biometric data is appended to the examination of a candidate at the termination of the exam. The identity of the test taker can later be confirmed by capturing biometric data from the purported test taker and comparing the captured data with the appended data.

According to another embodiment, test center administrators can be tracked during an examination by capturing biometric data at periodic intervals. For example, it can be determined whether test center administrators proctor the exam by walking around the room at predetermined times by capturing biometric data at each required instance.

According to another advantageous embodiment, the identity of an individual can be confirmed at events over the period of the individual's life. For example, biometric data can be captured from an individual at a standardized exam and appended to the examination results. The biometric data can also be stored in a database. At a point later in time, such as, for example, the registration for classes at a university, the identity of the individual can be determined by comparing captured biometric data with the data appended to the examination and/or data stored in the database.

The present invention allows for the capture, comparison and management of examination candidate biometric data. This allows for a greater protection of the intellectual property contained in examinations, the ability to validate candidate identity and provides continuity with new technology. Implementing biometrics in an examination environment also creates an improved audit trail for each exam, reduces variability in operations with respect to various identification requirements, allows data verification to be automated and can streamline test center operations.

As one example, biometric data such as, but not limited to, fingerprints, thumbprints, palm prints, retinal scans, and DNA may be captured by a biometric capture device when an examination candidate enters an examination testing location. If the examination candidate has previously sat for an examination, the biometric data will have been previously captured and stored in a database and will be available for comparison. By comparing the newly captured biometric data with the data stored in the database the system can perform many functions. These functions include, but are not limited to, determining whether the examination candidate is registered for the examination, increasing examination candidate check-in-efficiency, determining whether the examination candidate is qualified to sit for the examination (e.g., has waited the requisite amount of time since last taking the examination), determining whether the individual presenting themselves as the examination candidate is fraudulently providing identification, tracking examination candidates through the testing process, tracking the examination candidate from examination to examination, etc. Advantageously, the same or similar system can be used to ensure that the exam is being properly proctored, as described below in further detail.

These, together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a flow diagram of a prior art registration process;

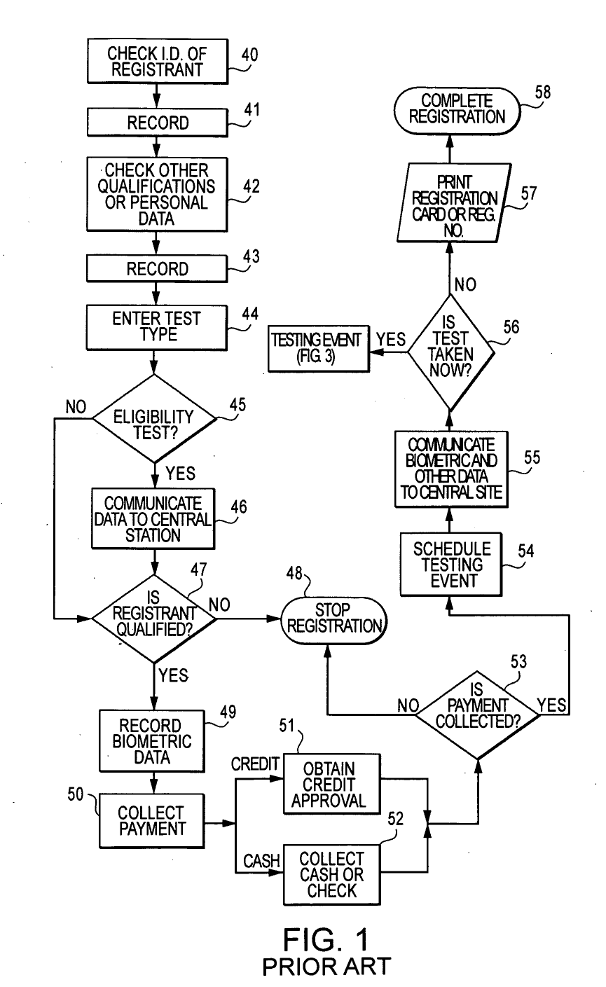

FIG. 2 is a flow diagram of a prior art test taking process in which the testing event is verified during the event;

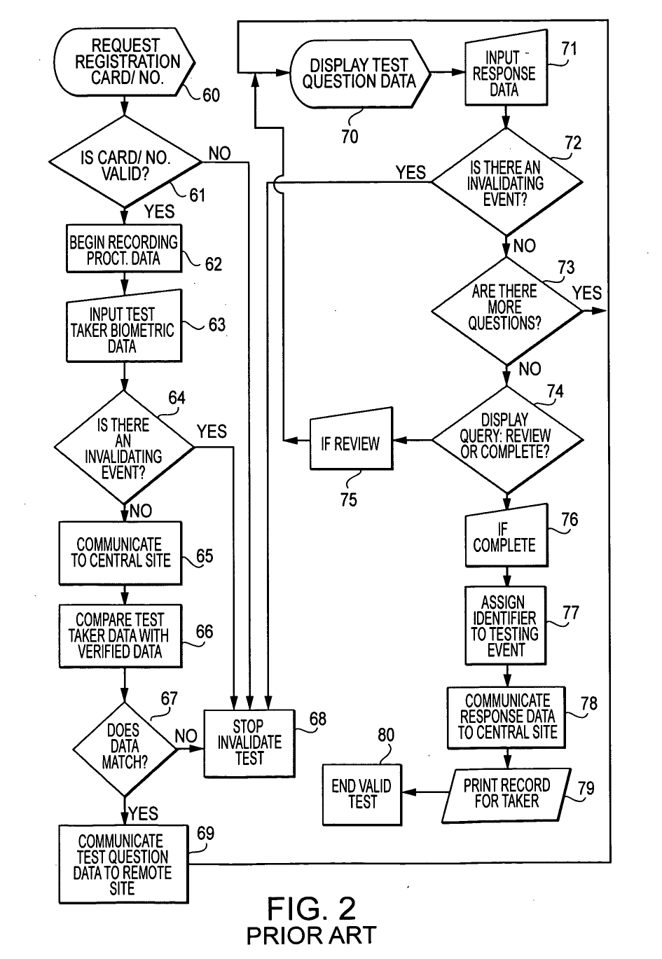

FIG. 3 is a flow diagram of the prior art central site activity during registration and testing in FIGS. 1 and 2;

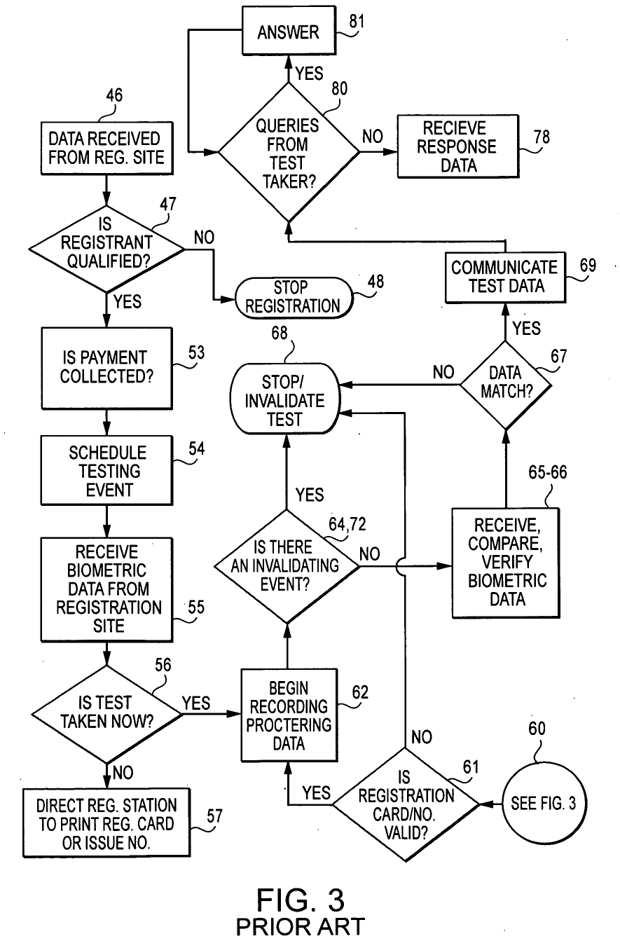

FIG. 4 is a schematic diagram of a prior art computer-based testing system;

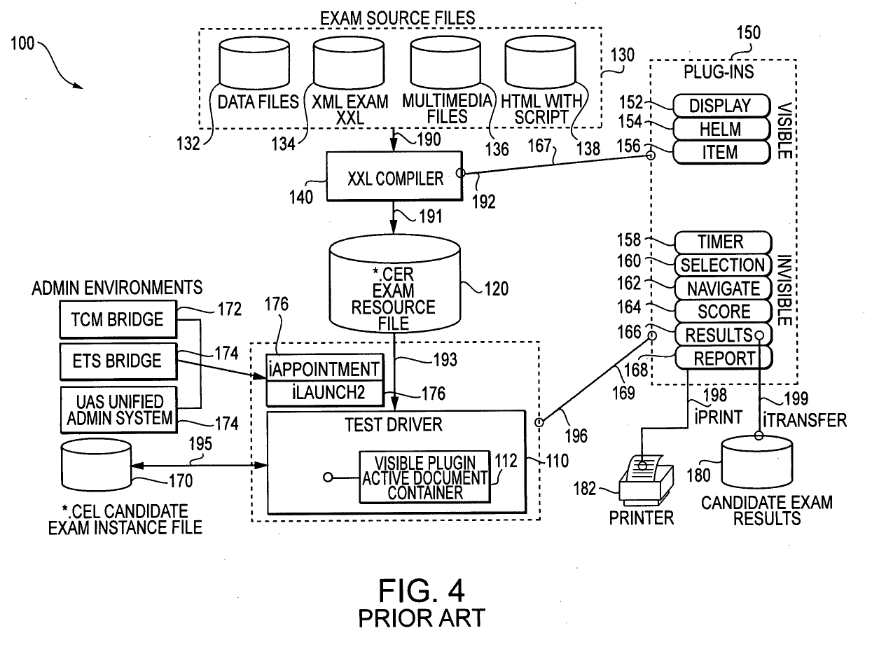

FIG. 5 is a flow chart of a prior art method of restarting a test after interruption;

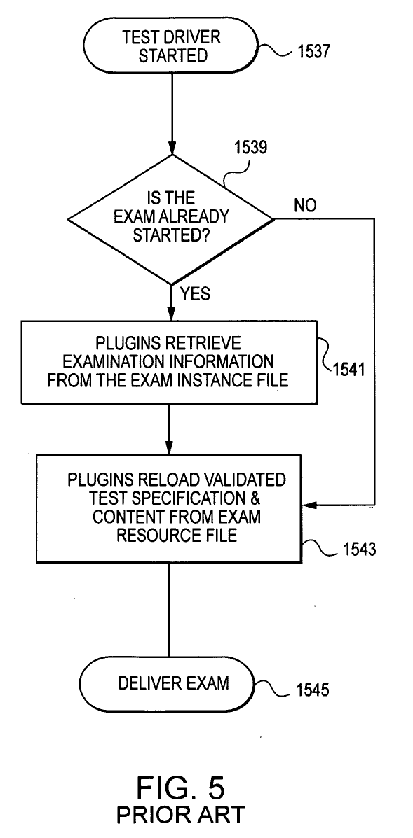

FIG. 6 is a diagram of a life cycle of a plug-in according to a prior art system and method;

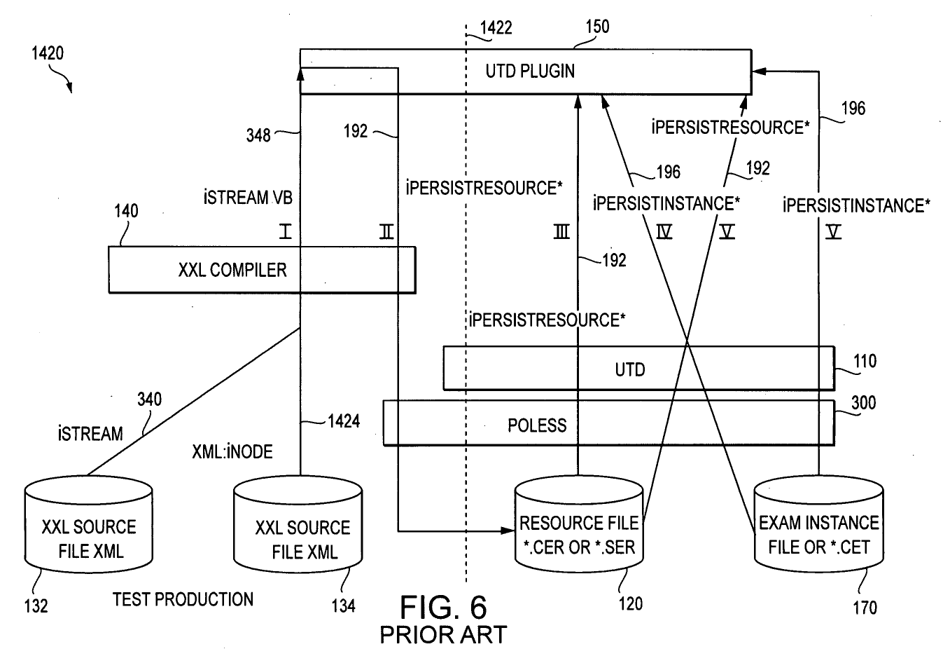

FIG. 7 depicts an embodiment of the candidate identity management system of the present invention;

FIG. 8 depicts an alternative embodiment of the candidate identity management system of the present invention;

FIG. 9 depicts a flow diagram of one embodiment of a method for proctor and candidate identity management of the present invention;

FIG. 10 depicts an alternative embodiment of the candidate identity management system of the present invention using a message queue;

FIG. 11 depicts an embodiment of the test center—data center communication of the candidate identity management system of the present invention using a message queue;

FIG. 12 depicts an embodiment of the UAS to NASD biometric data transfer of the candidate identity management system of the present invention using a message queue;

FIG. 13 depicts a flow diagram an alternative embodiment of a method for proctor and candidate identity management of the present invention;

FIG. 14 depicts the test center administrator start-of-business procedures;

FIG. 15 depicts the procedure for selecting an examination candidate for check-in;

FIG. 16 depicts one embodiment of the check-in procedure, wherein a pre-check message is supplied;

FIG. 17 depicts one embodiment of the check-in procedure, wherein a demographic update box is supplied;

FIG. 18 depicts one embodiment of the biometric identity verification for an examination candidate of the candidate identity management system of the present invention;

FIG. 19 depicts one embodiment of an alert that will be provided should an examination candidate identification not match identification stored in a database;

FIG. 20 depicts the procedure according to one embodiment of the present invention for a test control administrator to scan the identification of an examination candidate that is not already in the database;

FIG. 21 depicts the procedure for processing a fingerprint according to one embodiment of the present invention;

FIG. 22 depicts the procedure according to one embodiment of the present invention for an examination candidate fingerprint to be accepted or refused by a test center administrator;

FIG. 23 depicts the first portion of a procedure according to one embodiment of the present invention for a candidate to take a break during an examination;

FIG. 24 depicts the second portion of a procedure according to one embodiment of the present invention for a candidate to take a break during an examination;

FIG. 25 depicts the third portion of a procedure according to one embodiment of the present invention for a candidate to take a break during an examination;

FIG. 26 depicts the fourth portion of a procedure according to one embodiment of the present invention for a candidate to take a break during an examination;

FIG. 27 depicts the first portion of a procedure according to one embodiment of the present invention for a candidate to resume an examination;

FIG. 28 depicts the second portion of a procedure according to one embodiment of the present invention for a candidate to resume an examination;

FIG. 29 depicts the procedure according to the present invention depicts the procedure according to one embodiment of the present invention for a test control administrator to scan the identification of an examination candidate that is already in the database;

FIG. 30 depicts a post check in procedure for initiating the examination;

FIG. 31 is a chart listing the steps of a method according to one embodiment of the present invention;

FIG. 32 is a chart listing additional steps of a method according to one embodiment of the present invention;

FIG. 33 is a chart listing messages that appear to a test center administrator during a method according to one embodiment of the present invention;

FIG. 34 is a chart listing the data format requirements according to one embodiment of the present invention;

FIG. 35 is a flow chart depicting the steps of a method according to one embodiment of the present invention for managing the identity of an examination candidate, including a multi-stage, multi-phase, multi-period and/or multi-episode procedure for identifying and/or authenticating test examination candidates and/or individuals; and

FIG. 36 is a flow chart depicting the steps of a method according to another embodiment of the present invention for managing the identity of an examination candidate, including a multi-stage, multi-phase, multi-period and/or multi-episode procedure for identifying and/or authenticating test examination candidates and/or individuals.

### DETAILED DESCRIPTION OF THE PREFERRED EMBODIMENTS

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In the following description, reference is made to the accompanying drawings that form a part of the present disclosure, and in which are shown, by way of illustration, specific embodiments of the invention. These embodiments are described in sufficient detail to enable those skilled in the art to practice the invention, and it is to be understood that other embodiments may be utilized and that structural and other changes may be made without departing from the scope of the present invention. The present disclosure is, therefore, not to be taken in a limiting sense. The present disclosure is neither a literal description of all embodiments of the invention nor a listing of features of the invention that must be present in all embodiments.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “an embodiment”, “some embodiments”, and “one embodiment” mean “one or more (but not all) embodiments of the present invention(s)” unless expressly specified otherwise.

The terms “including”, “having,” “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The terms “a”, “an” and “the” mean “one or more”, unless expressly specified otherwise.

Headings of sections provided in this patent application and the title of this patent application are for convenience only, and are not to be taken as limiting the disclosure in any way.

The present invention allows for the capture, comparison and management of examination candidate biometric data. As one example, biometric data such as, but not limited to, fingerprints, thumbprints, palm prints, retinal scans, and DNA may be captured by a biometric capture device when an examination candidate enters an examination testing location. If the examination candidate has previously sat for an examination, the biometric data will have been previously captured and stored in a database and will be available for comparison. By comparing the newly captured biometric data with the data stored in the database the system can perform many functions. These functions include, but are not limited to, determining whether the examination candidate is registered for the examination, increasing examination candidate check-in-efficiency, determining whether the examination candidate is qualified to sit for the examination (e.g., has waited the requisite amount of time since last taking the examination), determining whether the individual presenting themselves as the examination candidate is fraudulently providing identification, tracking examination candidates through the testing process, tracking the examination candidate from examination to examination, etc. Advantageously, the same or similar system can be used to ensure that the exam is being properly proctored, as described below in further detail.

The present invention allows for the capture, comparison and management of examination candidate biometric data. This allows for a greater protection of the intellectual property contained in examinations, the ability to validate candidate identity and provides continuity with new technology. Implementing biometrics in an examination environment also creates an improved audit trail for each exam, reduces variability in operations with respect to various identification requirements, allows data verification to be automated and can streamline test center operations.

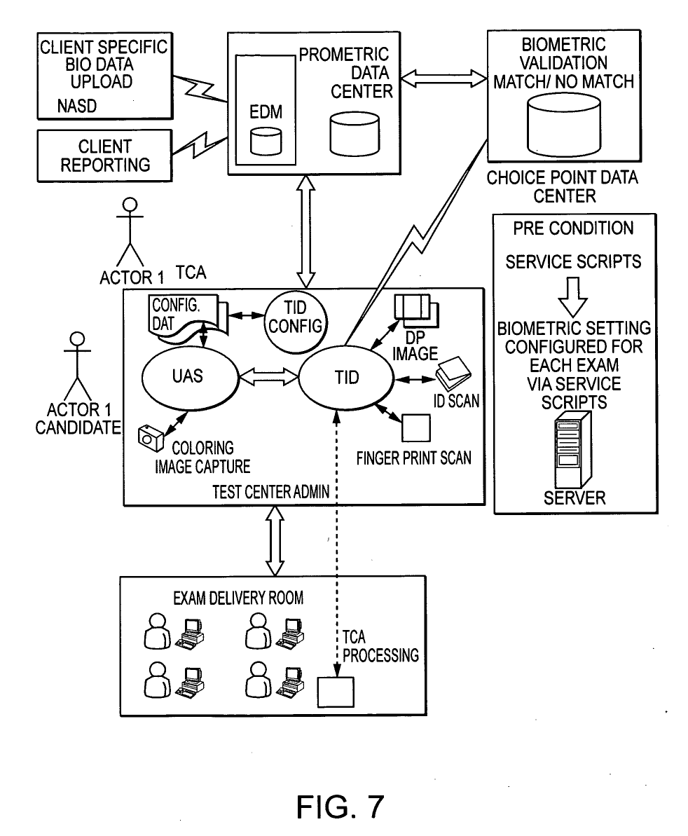

FIG. 7 depicts an embodiment of the candidate identity management system of the present invention. The figure shows a Prometric data center, a third party biometric data validation center, a server, an exam delivery room containing one or many workstations, and an administration station used by a test center administrator (TCA) for both checking in and administering an examination to examination candidates.

The administration station is equipped with standard software and hardware components to check in candidates and to monitor candidates during the exam. In a preferred embodiment, the administration station is provided with peripheral devices for data capture such as a fingerprint scanner, a retinal scanner, a flatbed scanner, optical character recognition scanner, a license reader, a video camera and a digital still. One of skill in the art will recognize that any number of peripheral devices for capturing biometric and identification information may be provided without departing from the spirit of the invention.

Workstations are provided for examination candidates to take the exam. In a preferred embodiment the workstations contain standard software and hardware components to deliver the exam to the candidate, for example, as described in U.S. Pat. No. 5,915,973, incorporated herein by reference, although other embodiments are envisioned. In one embodiment, software running on the administration station controls the workstations. In another embodiment, biometric capture devices capture biometric data from examination candidates to initiate an examination, to allow examination candidates to check-out for breaks and to check-in from breaks, to record biometric data at regular intervals during examinations, and to terminate an examination. The biometric capture devices may be used to track the amount of time each candidate is actively taking an examination by associating a time with each examination candidate's check-out and check-in. The biometric capture devices may also be used to prevent another individual from sitting in the workstation of an examination candidate locking out any individual that does not match the examination candidate that was using the workstation. The biometric capture devices may allow examination candidates to use any workstation (i. e., when an examination candidate checks in at another work station, the biometric data of the examination candidate is used to provide the correct examination at the location where the candidate took a break). The biometric capture devices may also be used to prevent fraud by ensuring that the same examination candidate began the exam after each break, and terminated the exam.

A server is provided that provides file and printing services. The service stores examination contents, examination candidate outcome files as well as examination rosters and other information.

As shown, the data center advantageously includes a rule set to configure the biometric data setting for each exam through, for example, service scripts that will be used for identifying the devices used for biometric and identity capture. A third party provider, in this case Choice Point, provides each testing site with a True ID user ID and password, although other standard applications may optionally be used.

True ID is a third party software application that provides serves such as biometric data capture, storage and validation. True ID is provided with a configuration file that defines the behavior of the True ID application. For example, the configuration file can be used to enable and disable fingerprint requirements, allow a TCA to override the biometric data capture requirement if the data capture fails for any reason, disable connection to the third party biometric data validation center and use a location database instead, and write biometric data to a biometric outcome file if the connection to the third party data validation center is disabled.

A unified administration system (UAS) application, for example, as provided by the assignee of the present invention or other standard test administration systems (such as the Questionmark's Perception assessment management system; The Examiner Corporation's The Examiner System, the test administration system offered by Polaris Assessment Systems, Inc., and/or TRAC Systems' Online Testing System) and/or other standard bio-identity management systems, invokes True ID, which resides on the TCA workstation and which captures and sends biometric data to Choice Point for validation. TCAs can use the UAS application to check-in examination candidates and to both deliver and monitor examinations. A response indicating the validation status of the biometric data is received by True ID from Choice Point.

According to one embodiment of the present invention, the administration station is equipped with a biometric capture device for monitoring the activity of a TCA. Biometric data may be captured from a TCA and stored in a database when the administrator is hired or at some point prior to an exam being proctored. When a TCA arrives at a test center, the TCA can login to the system by providing biometric data for comparison with the previously stored data. This allows the system to ensure that only authorized individuals have access to the testing system and can administer examinations.

According to another embodiment, a TCA may be required to walk through the testing room to proctor or monitor the examination candidates' activities. To ensure that the TCA is complying with the proctoring responsibilities, the system may require the TCA to provide biometric data to check-in and check-out each time the TCA performs a walk-through. According to another embodiment, the system may provide a warning or a notification to the TCA as an indication that the next walk-through is required at regular intervals (e.g. every ten minutes). The length of the intervals can be configurable. According to another embodiment, the check-out and check-in procedure would reset a timer to begin the next time interval.

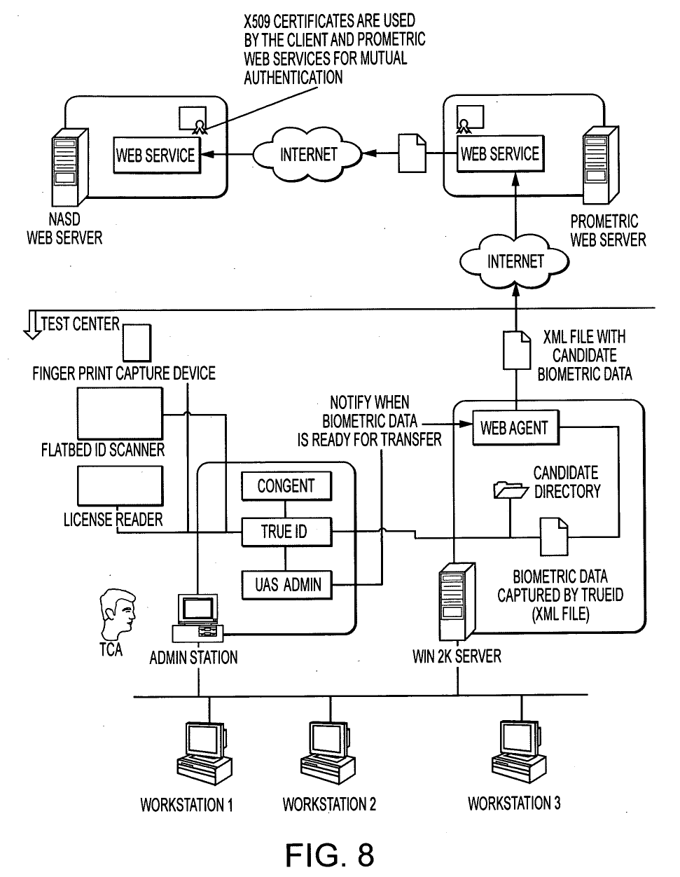

FIG. 8 depicts an alternative embodiment of the candidate identity management system of the present invention. In an alternative embodiment, the biometric data validation center can be replaced by a test client, here NASD. Biometric data are transferred to the test client via the Internet where it can be stored or compared with previously stored biometric data.

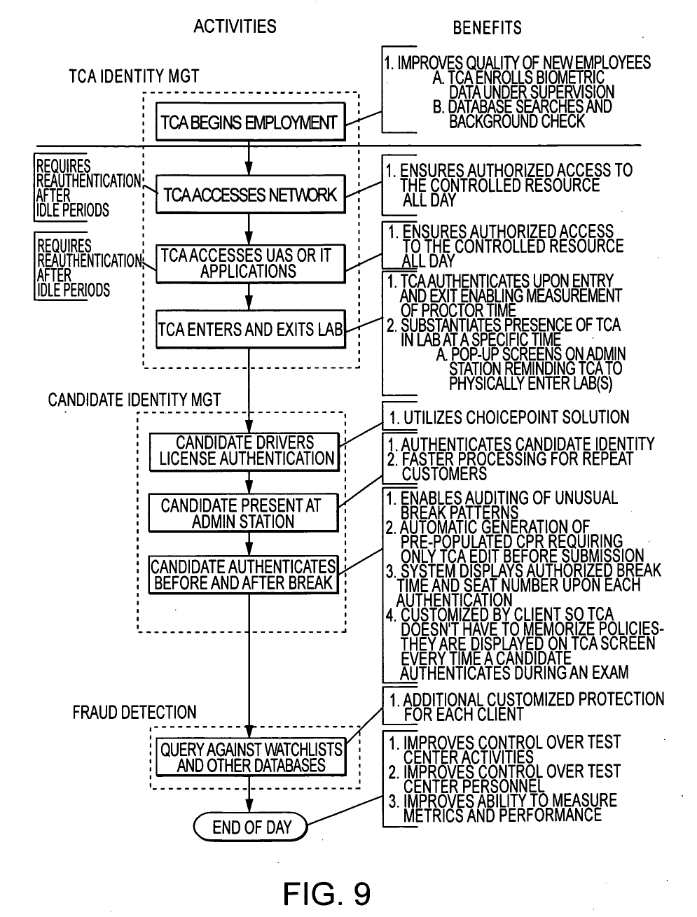

FIG. 9 depicts a flow diagram of one embodiment of a method for proctor and candidate identity management of the present invention. As discussed above, according to one embodiment of the present invention, biometric data is captured from a TCA when the TCA begins employment or at some point in time prior to an exam being proctored, and stored in a database. By capturing biometric data at this time, background checks and other searches may be performed using the biometric data to ensure that the TCA is qualified to administer examinations. According to another embodiment of the present invention, a list of individuals that have been barred from owning or administering testing centers is maintained. Biometric data from a TCA can be compared against the list of barred individuals to ensure that a TCA or test center owner is not improperly administering an examination.

According to another embodiment of the invention, the system requires the TCA to provide biometric data to login to the system at an administration station. The biometric data will be compared with the previously stored biometric data, the system can ensure that only authorized individuals can access the system. As shown, this process may be required after idle periods to prevent unauthorized access to an administration system. Further, a TCA may be required to provide biometric data to enter or exit a testing lab, according to another embodiment of the present invention. This may be used to track the location of a TCA in a test center, to ensure the TCA is following proctoring requirements according to a predetermined schedule, etc.

Also shown, a step is provided for capturing examination candidate driver's license information at the administration station. This may be performed by scanning the driver's license on a flatbed scanner or swiping the license in a license reader to authenticate the identification. The driver's license information, including but not limited to, the license photo, the license number, the licensee name and licensee address may be appended to the examination candidate's exam.

The next step, as shown, requires the examination candidate to provide biometric data at the administration station. As described previously, this information can be compared with previously captured data to determine whether the examination candidate's biometric data and drivers license identification match. This data can also be used to identify the examination candidate during the test administration and may be appended to the candidate's examination, according to certain embodiments of the present invention.

Next, as shown, the examination candidate is required to authenticate their identification before and after each break from the exam. This can be performed by capturing biometric data from the examination candidate and comparing it against previously captured biometric data to ensure that the same examination candidate re-enters the exam. As well, the seat number associated with the examination candidate can advantageously be stored and then displayed to the examination candidate after authentication from a break to ensure the candidate resumes the examination in the correct seat and/or for validation purposes by the exam proctor.

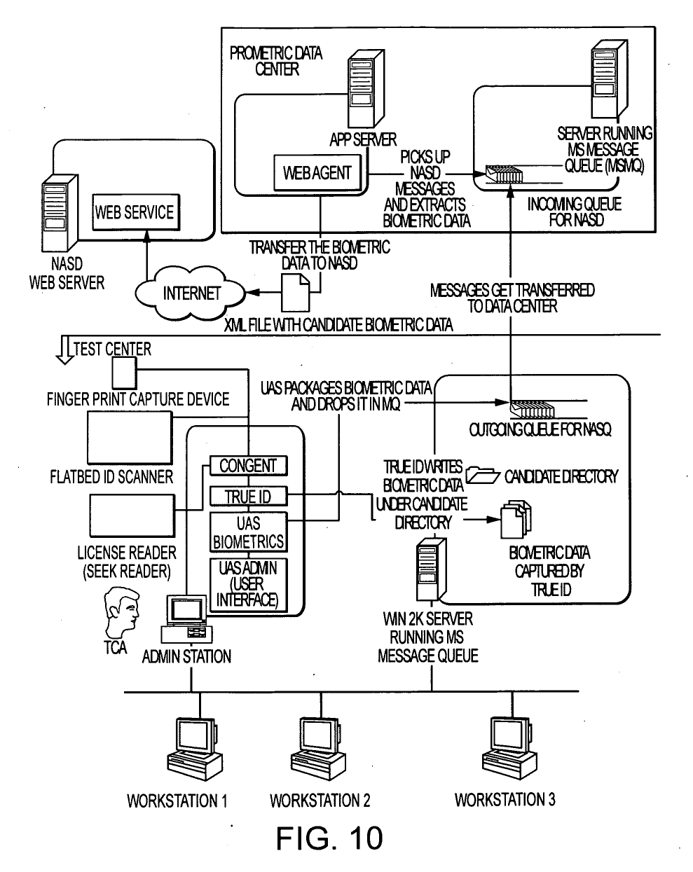

FIG. 10 depicts an alternative embodiment of the candidate identity management system of the present invention using a message queue. A Microsoft Message Queue is used to collect biometric data from examination candidates and is transferred to a data center via a dedicated ISDN line.

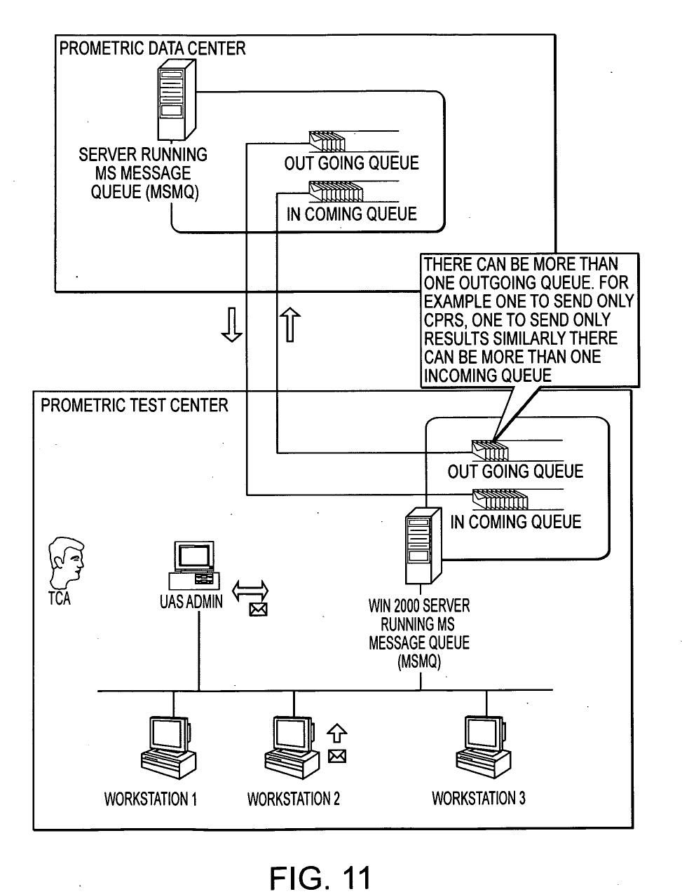

FIG. 11 depicts another embodiment of the candidate identity management system of the present invention. The figure depicts the test/data center communication of the candidate identity management system of the present invention using a message queue. Advantageously, there can be more than one outgoing and more than one incoming queue used for sending center problem reports (CPRs).

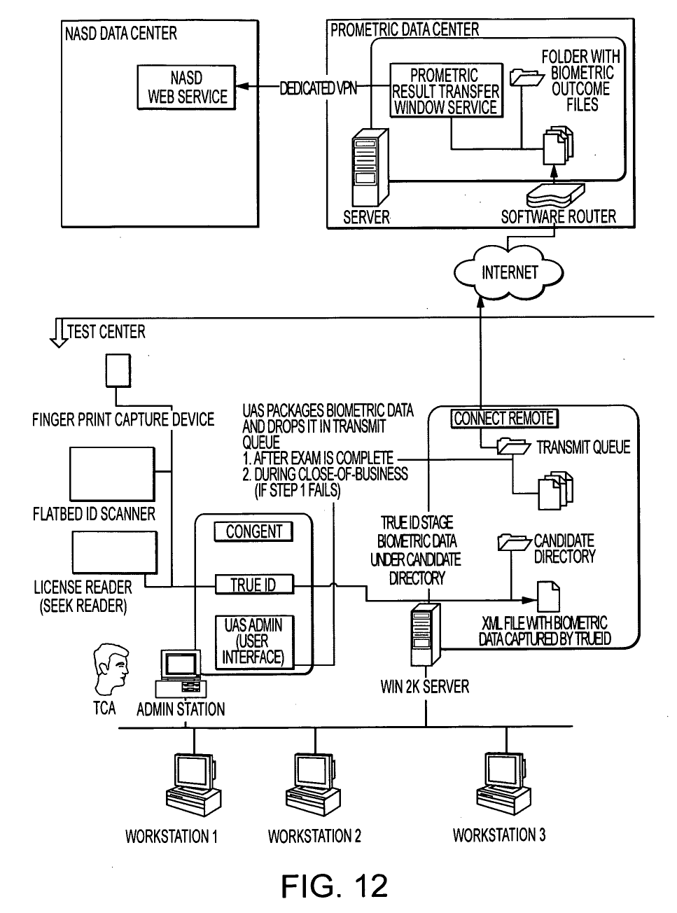

FIG. 12 depicts another embodiment of the candidate identity management system of the present invention. The figure depicts the UAS to NASD biometric data transfer of the candidate identity management system of the present invention using a message queue. As depicted the administration station contains Cogent, which is used to perform quality checks on the biometric data captured from examination candidates as well as the TCAs. The UAS packages the biometric data and places it into the transmit queue for transmission to the NASD data center after the examination is complete. Alternatively, the biometric data can be transmitted to the NASD data center at the close of business if the first transmission attempt fails.

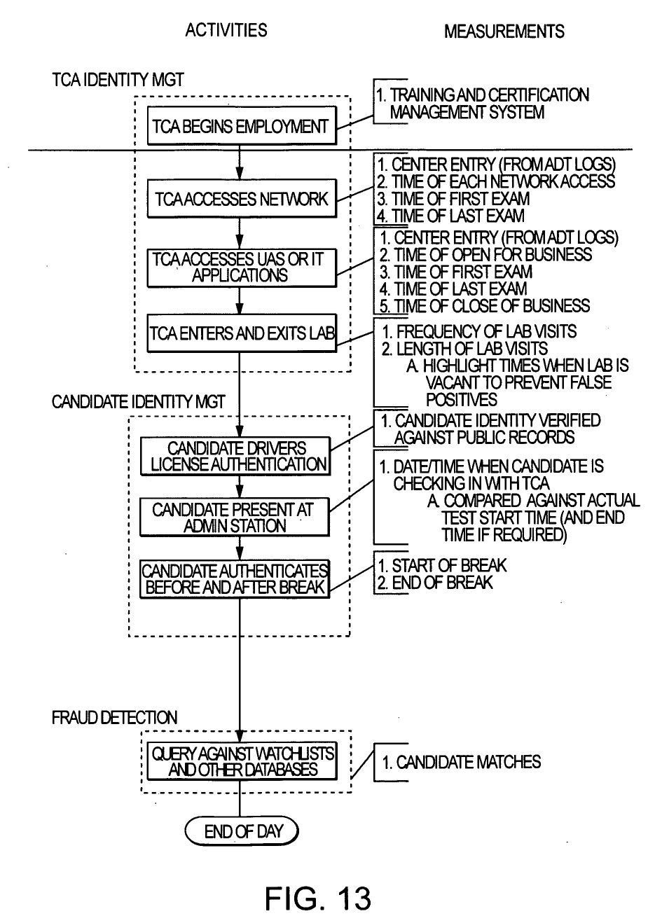

FIG. 13 depicts a flow diagram of another embodiment of a method for proctor and candidate identity management of the present invention. As discussed above, according to one embodiment of the present invention, biometric data is captured from a TCA when the TCA begins employment and stored in a database. The system can be updated with information stating that the TCA has completed training and certification to allow the TCA to administer examinations, which is associated with the TCA biometric data stored in the database.

As shown in the next step, the TCA must be login to the system to access the network. At this tine, biometric data captured from the TCA can be compared with the previously stored data to determine whether there is a match. As well, the system can determine whether the TCA has completed the training and certification for administering examinations by accessing the associated data and preventing the TCA from accessing the network if the requisite training has not been completed.

Further, as shown in this and the next step, the TCA may be required to provide biometric data at the time of each network access, at the time of the administering the first exam of the day, at the time of administering the last exam of the day, each time the TCA enters the test center, the time that the test center is open for business and the time of the close of business for the test center.

Also shown, a step is provided for capturing examination candidate driver's license information at the administration station. This may be performed by scanning the driver's license on a flatbed scanner or swiping the license in a license reader to authenticate the identification. The driver's license information, including but not limited to, the license photo, the license number, the licensee name and licensee address may be appended to the examination candidate's exam. As well, the driver's license information may be verified against public records to ensure its authenticity.

The next step, as shown, requires the examination candidate to check in with the TCA at the administration station. This may be performed by capturing biometric data from the examination candidate. As indicated, the time that candidate checks in may be noted and compared against the actual start and end times of the examination, or may be stored for later comparison.

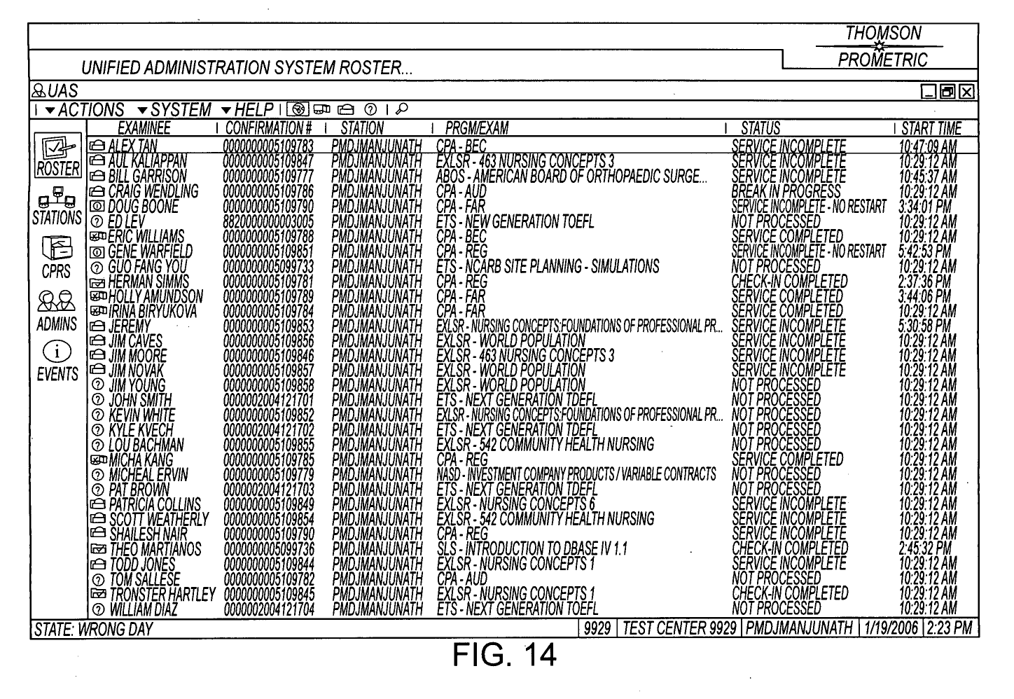

FIGS. 14-30 depict the step-by-step process for applying biometric identity management and candidate check-in procedures according to the preferred embodiment of the present invention. Each figure depicts a screen that may be presented at the administration station. In alternative embodiments, the screens may be presented at examination workstations. Each figure will be described individually below. Those of skill in the art will recognize that the steps described below may be performed in another order and that the identification information and biometric data captured from the examination candidate may differ without departing from the spirit of the present invention. A Frequently Asked Questions (FAQ) sheet prepared for the check-in procedure has been attached as Appendix A.

FIG. 14 depicts the start of business procedures performed by the TCA, which brings up the UAS. The screen allows the TCA to view the roster of examination candidates for the testing location and begin check in procedures.

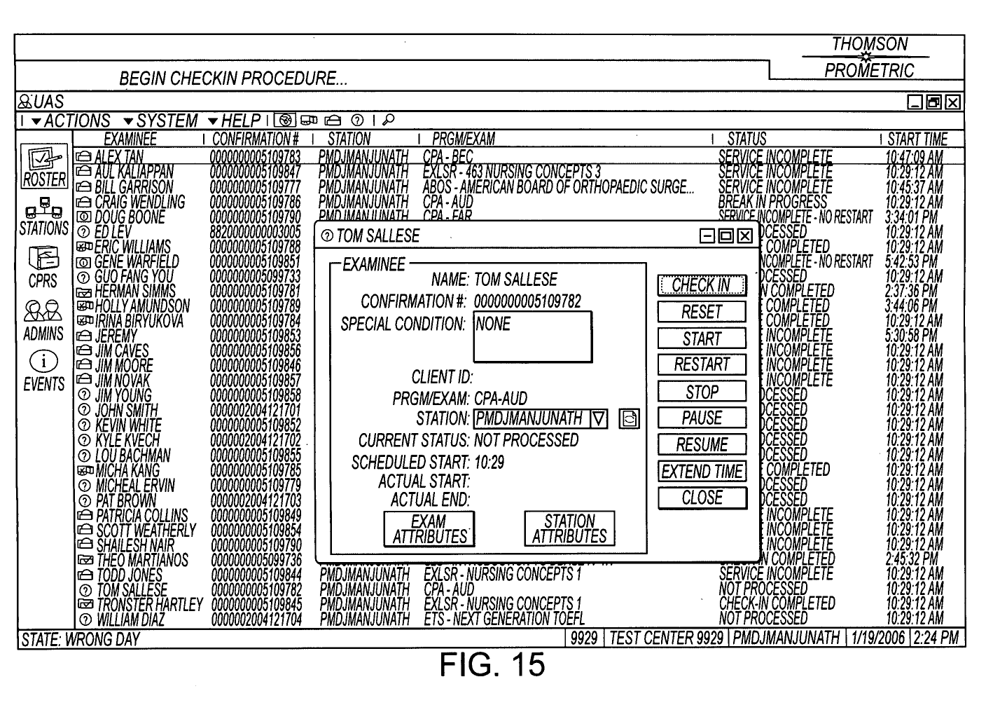

FIG. 15 depicts the procedure for checking in an examination candidate at the testing center. The TCA selects the appropriate examination candidate from the roster and selects the “check-in” button from the pop-up box.

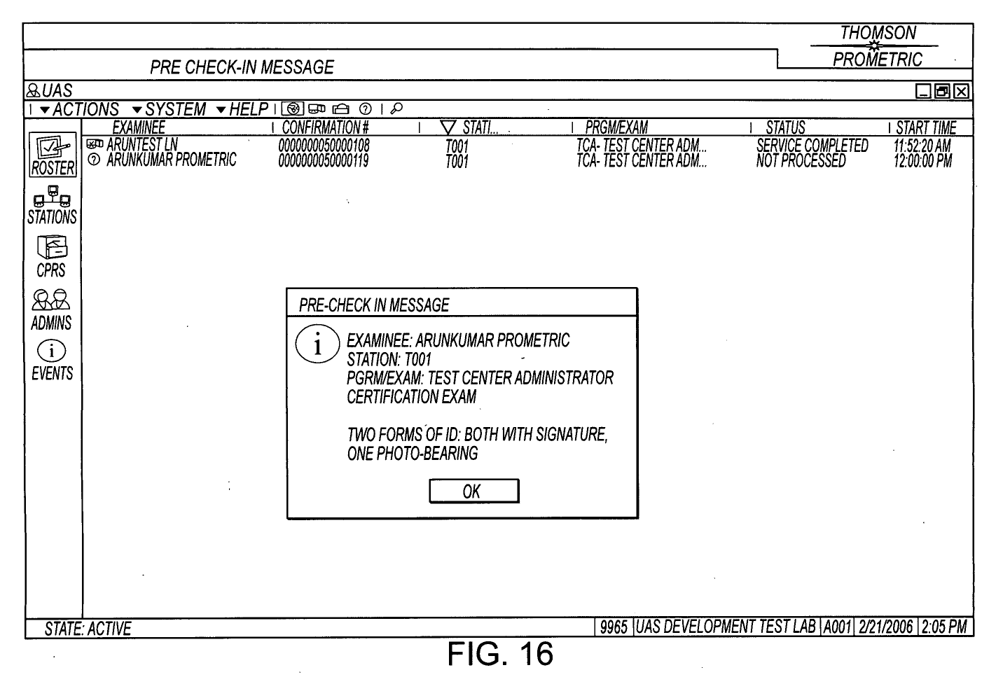

FIG. 16 a step according to an alternative embodiment wherein a client-specific message is displayed for a particular examination check in procedure.

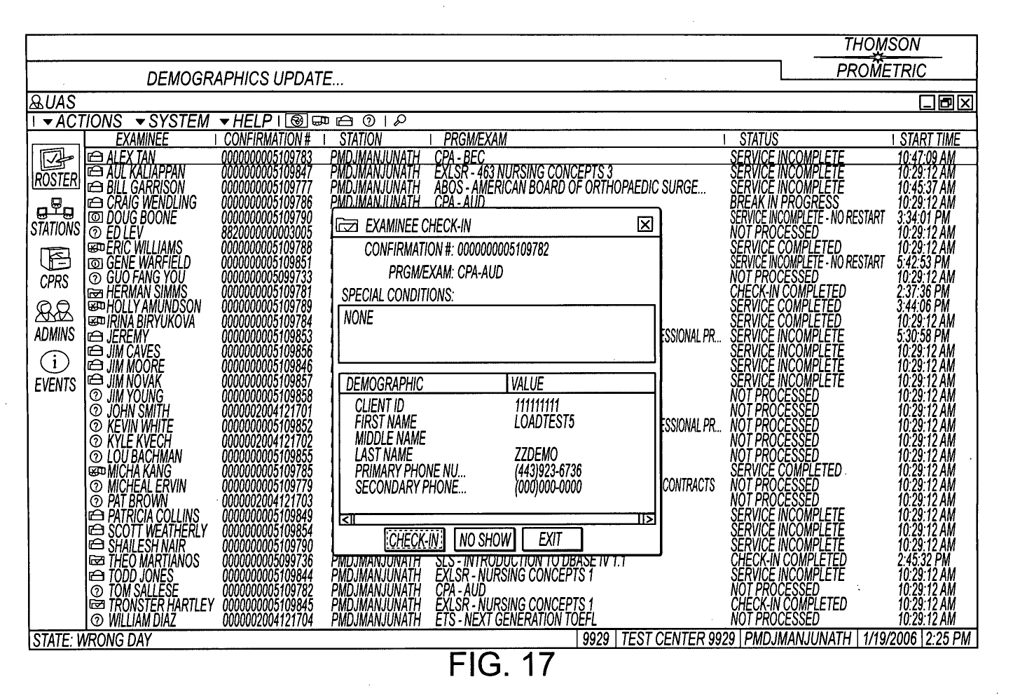

FIG. 17 depicts a step for updating demographic information during the check in procedure. If no update is required, the TCA may skip the step by selecting a “check-in” button on the pop-up box.

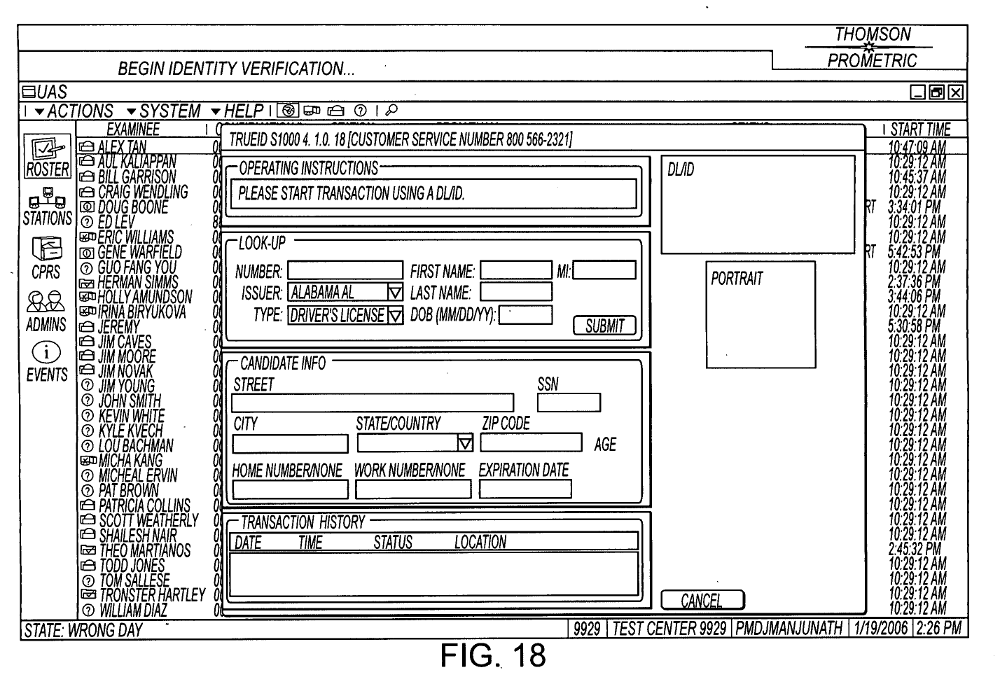

FIG. 18 depicts the beginning of the examination candidate biometric data capture. A specific procedure will be followed depending on the type of identification to be presented and captured. According to one embodiment, a different procedure is followed for non-drivers license identification, an example of which has been attached as Appendix B. One embodiment of the procedure for scanning identification is attached as Appendix C. According to another embodiment, another procedure described in Appendix D is followed when it is determined the identification presented is expired.

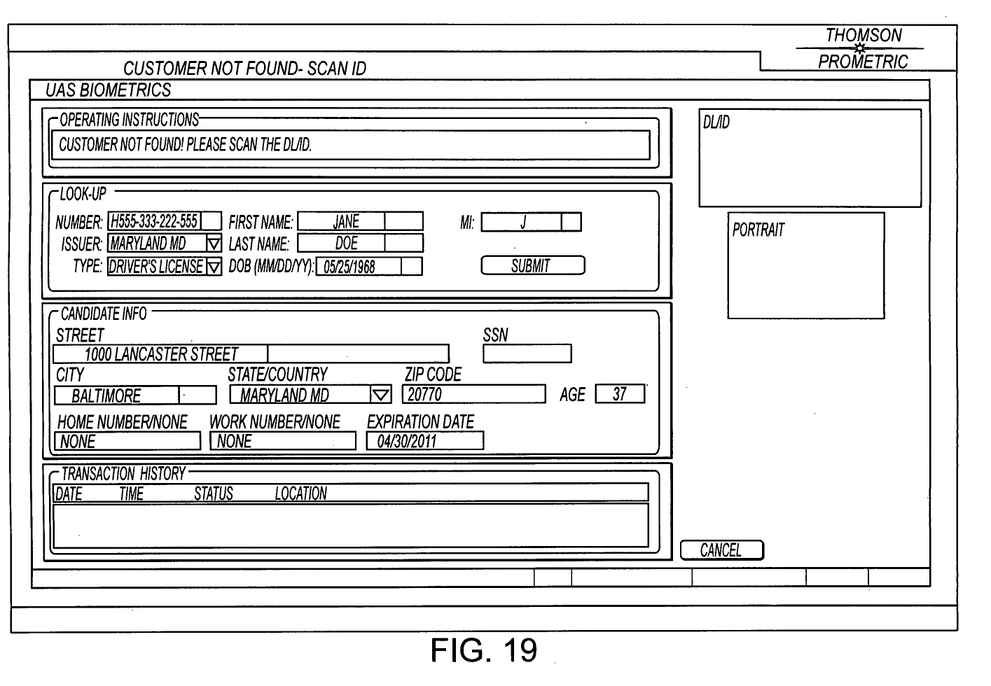

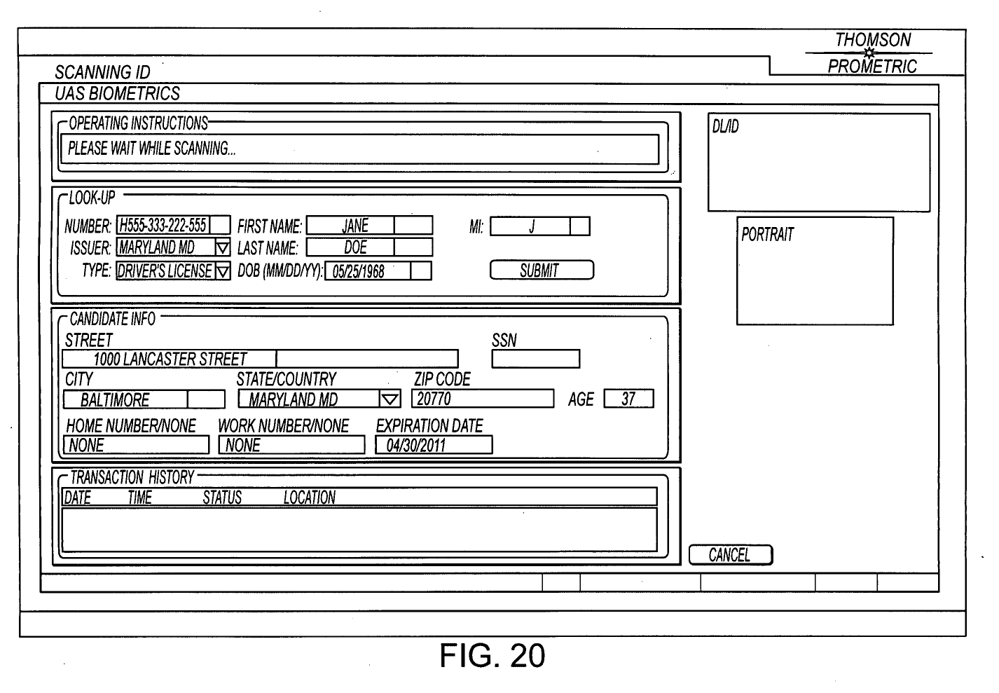

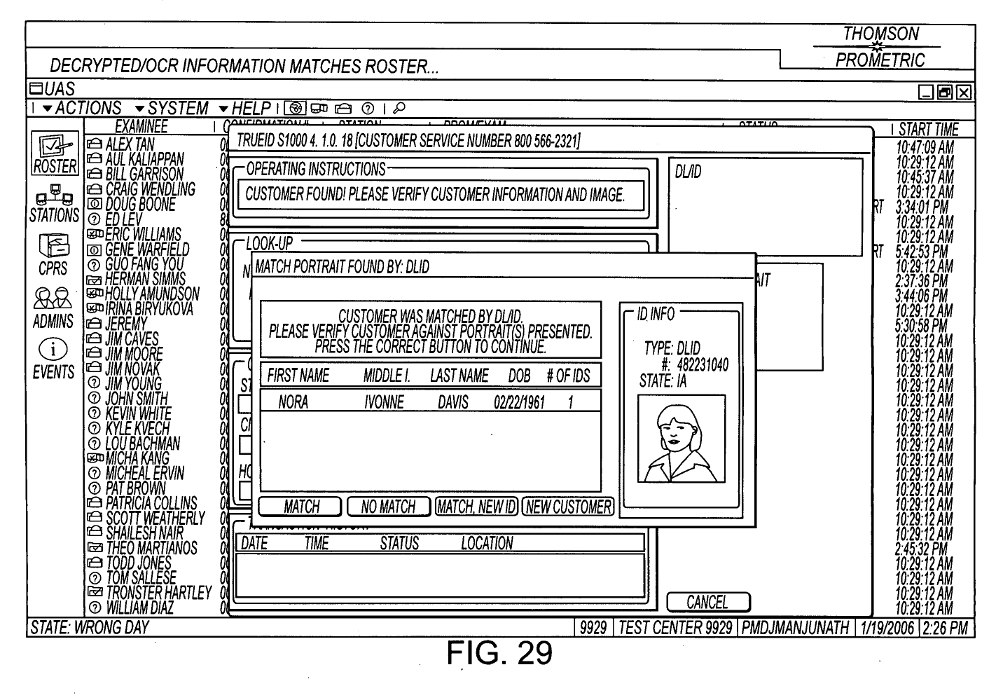

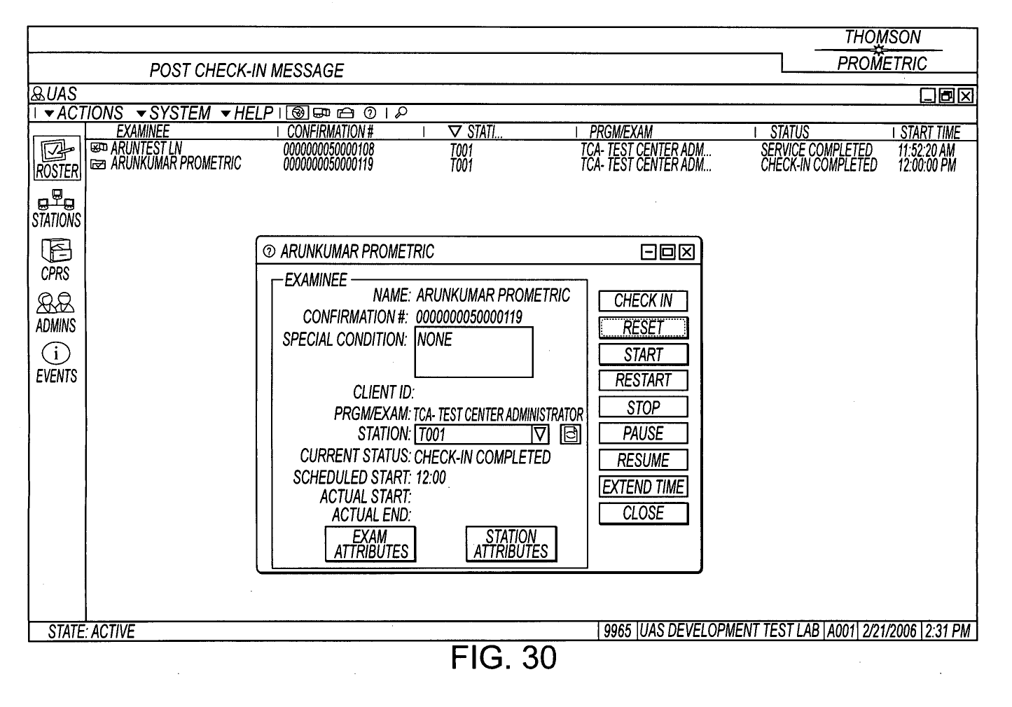

FIG. 19 depicts the procedure for capturing examination candidate biometric data that are not already in the database. For example, after capturing the photo identification of the examination candidate and determining that the information does not match data stored in the database, an alert may be presented to the TCA. If it is determined that the candidate biometric data does not match any of the data stored in the database, the TCA will follow the procedures described in FIGS. 20 through 22. If it determined that the candidate biometric data does match data stored in the database, the TCA will follow the procedures depicted in FIGS. 29 through 30.

FIG. 20 shows the procedure for entering the biometric data of the examination candidate into the system. As shown in the figure, the TCA will can the driver's license of the examination candidate for storage in the database.

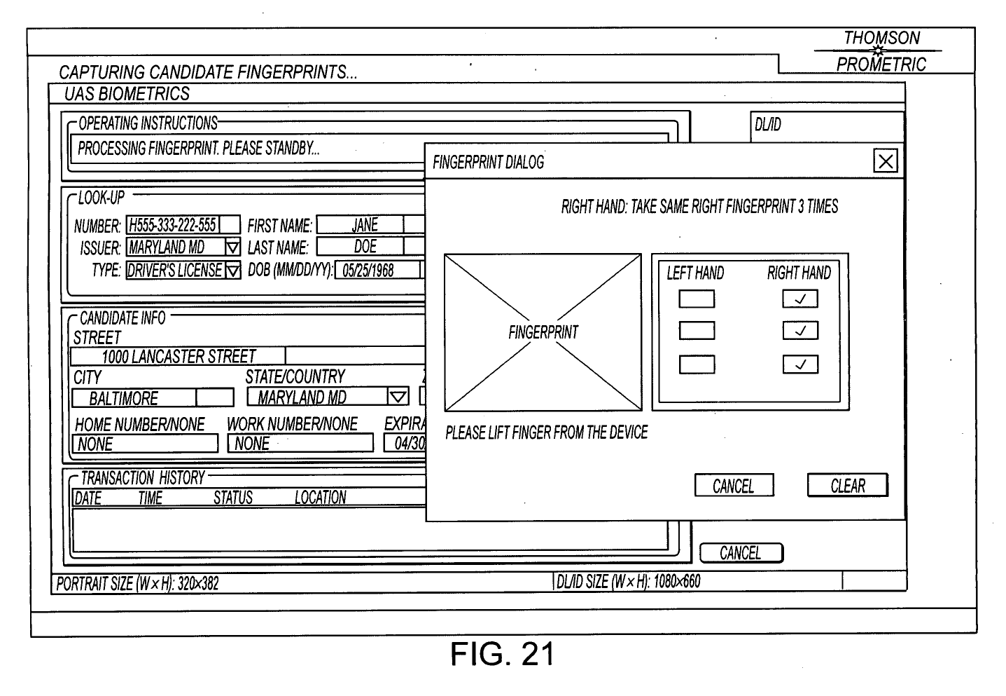

Next, as shown in FIG. 21, the examination candidate will have fingerprint data captured by the TCA at the administration station. According to the preferred embodiment, the driver's license and fingerprint data are stored in a database. Further, alternative embodiments envision capturing multiple fingerprints for storage in the database.

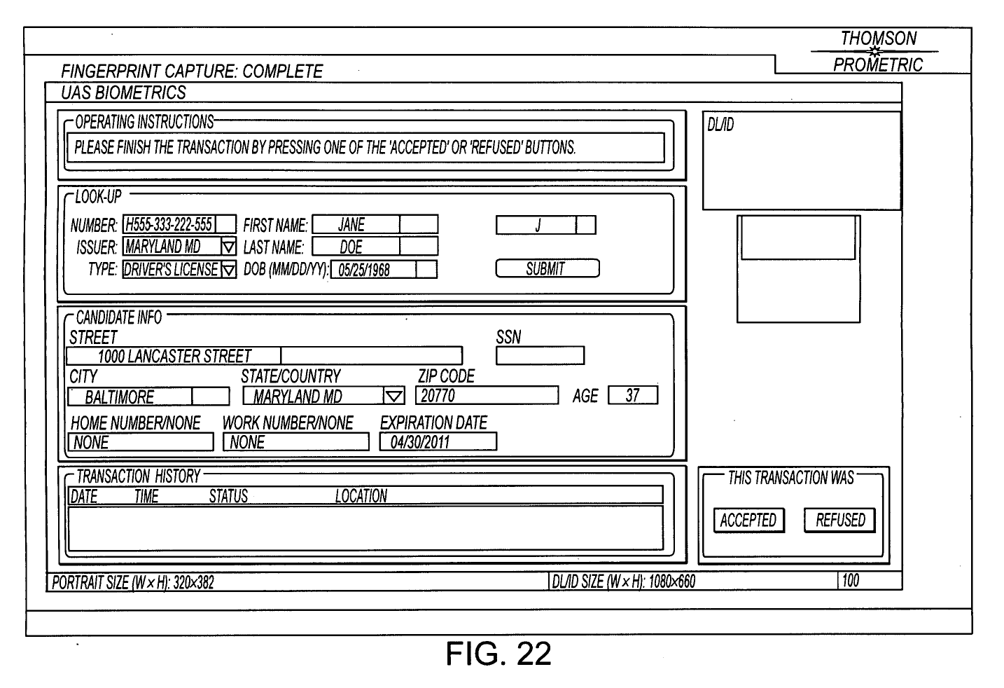

The last step of the check in process is depicted in FIG. 22. As shown, the TCA will finished the fingerprint transaction by selecting either the “Accepted” or “Refused” buttons on the screen as appropriate. The TCA may select “Refused” when the fingerprint scanner is incapable of producing a sufficiently accurate fingerprint scan for storage in the database.

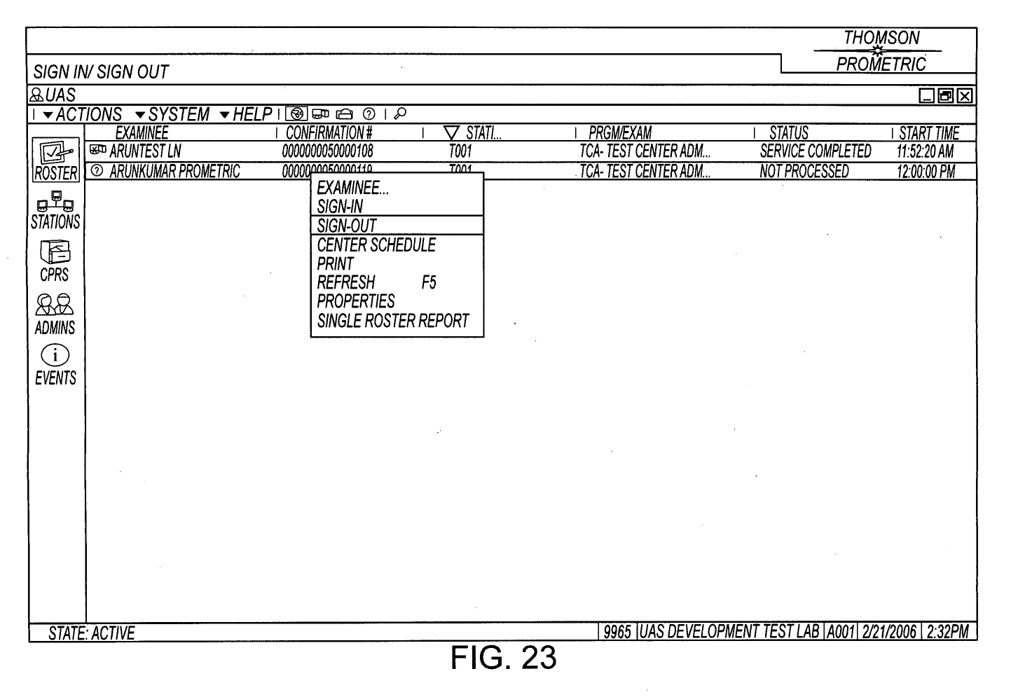

The procedures for checking an examination candidate out for a break from the examination and checking back in from a break according to the preferred embodiment are depicted in FIGS. 23 through 28. The same procedures may be used to check an examination candidate out from the examination at the end of the test. Each figure will be discussed individually below.

FIG. 23 depicts the beginning of the procedure for checking an examination candidate out for a break. As shown, when an examination candidate wishes to take a break from the exam, or when a regularly schedule break occurs, the TCA selects the appropriate candidate's name from a menu and selects “Sign-Out.”

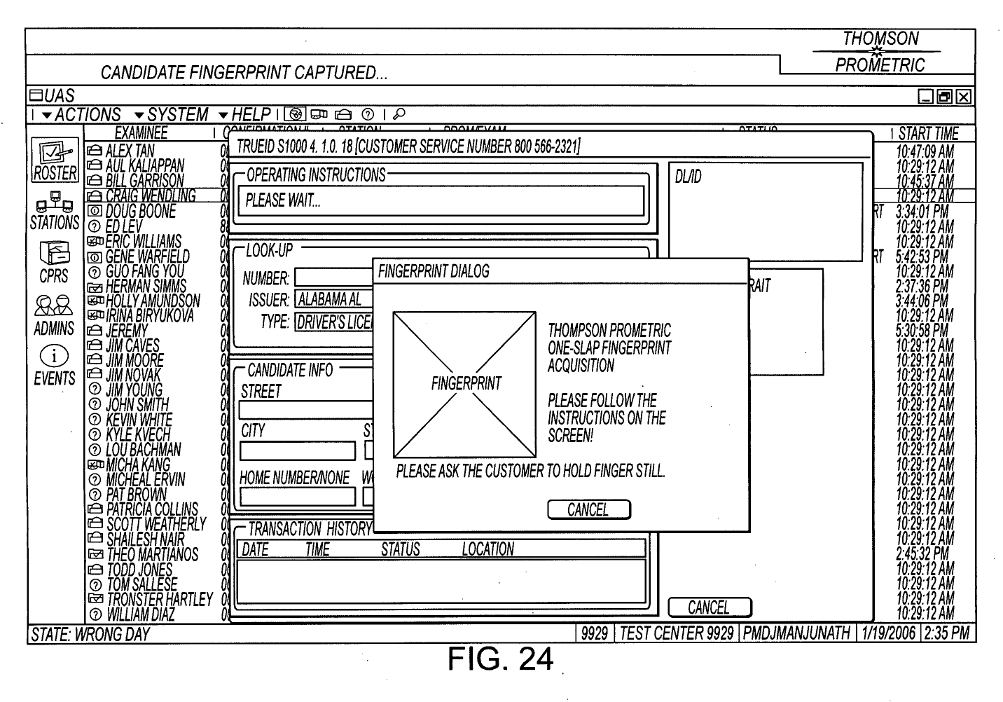

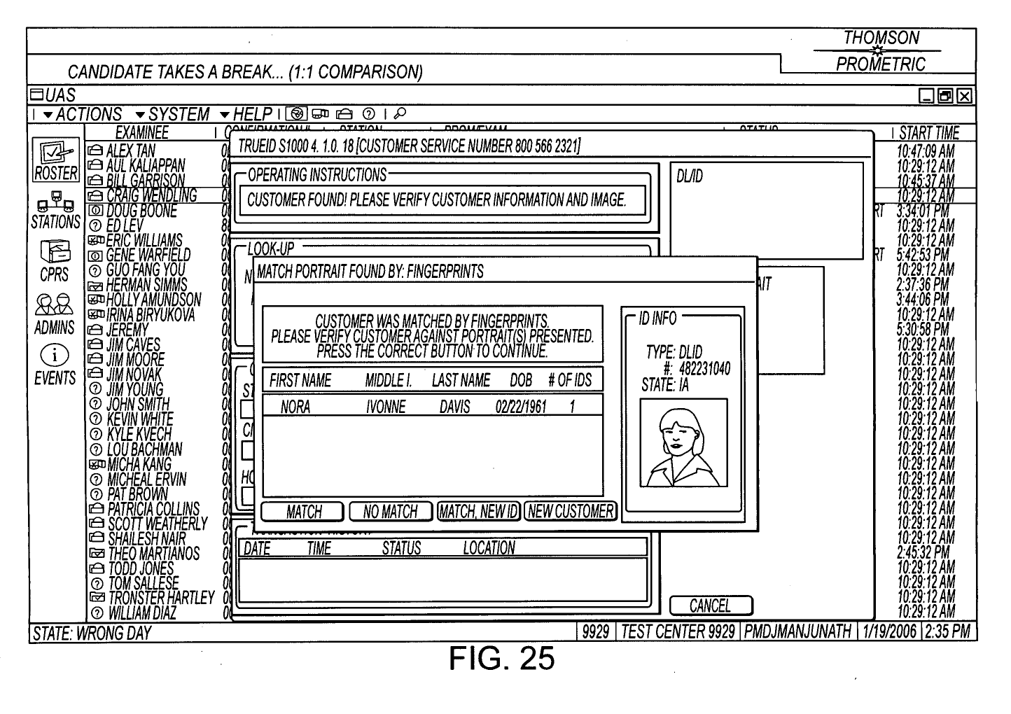

As shown in FIG. 24, the TCA will next capture fingerprint data from the candidate. As shown in FIG. 25, if the fingerprint matches a previously captured fingerprint the photo of the examination candidate will be displayed to the TCA for visual confirmation. According to one embodiment of the invention, the photo displayed is the originally captured driver's license photo of the examination candidate.

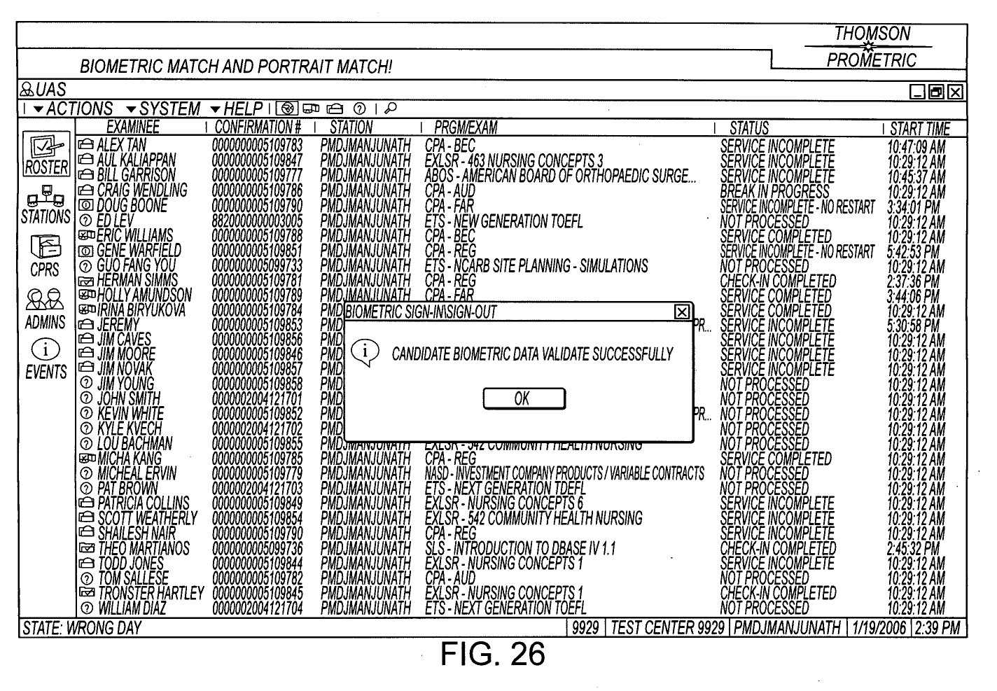

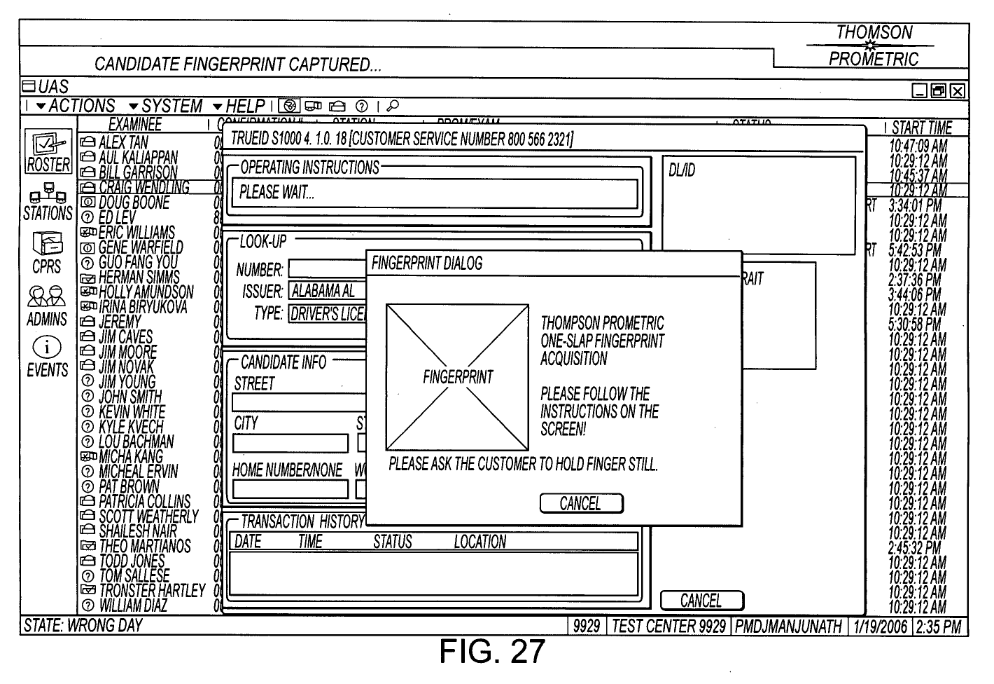

FIG. 26 depicts the roster of candidates present for the examination. After verifying that the candidate matches the image presented on the screen, shown in FIG. 25, the TCA will select “Match” and the examination candidate will be permitted to take a break. Upon return from the break, the TCA will repeat the procedure. The TCA will select the appropriate candidate's name from the roster and select “Sign-In” from the menu. As shown in FIG. 27, the candidate will again provide a fingerprint that will be matched with the candidate.

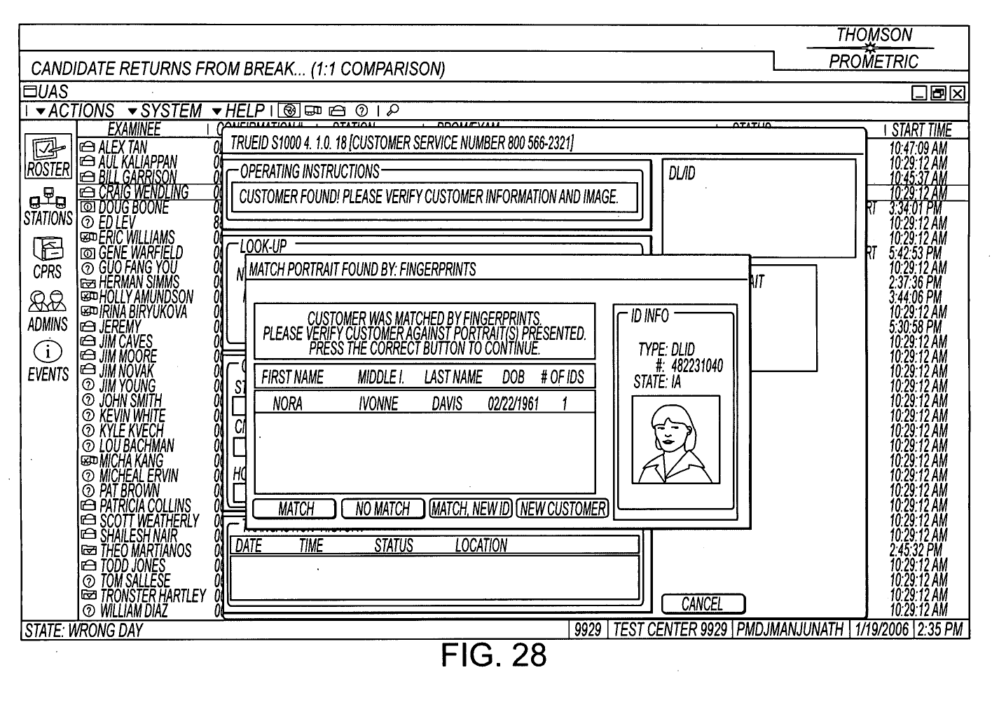

Again, as shown in FIG. 28, the originally captured photo corresponding to the fingerprint will be presented to the TCA on a screen. The TCA will verify that the returning candidate matches the image presented on the screen and the TCA will select “Match” from the menu. The examination candidate will then be allowed to return to their seat to resume testing.

FIG. 29 depicts the procedure for checking in an examination candidate that is already in the system. Similarly to the procedure describe above with respect to checking in an examination candidate from a break, the candidate's photo and biographic information will appear on the screen for verification by the TCA. The TCA will match the information on the driver's license with the biographic information on the roster as well as compare and match the photo on the driver's license with the candidate checking in. the TCA will then select “Match” from the menu to check the candidate into the exam.

FIG. 30 shows the procedure for initiating the examination according to the preferred embodiment of the present invention. As shown, once the biometric data capture process has been completed, a post check in message appears on the administration station screen. The TCA selects start to begin the candidate's test.

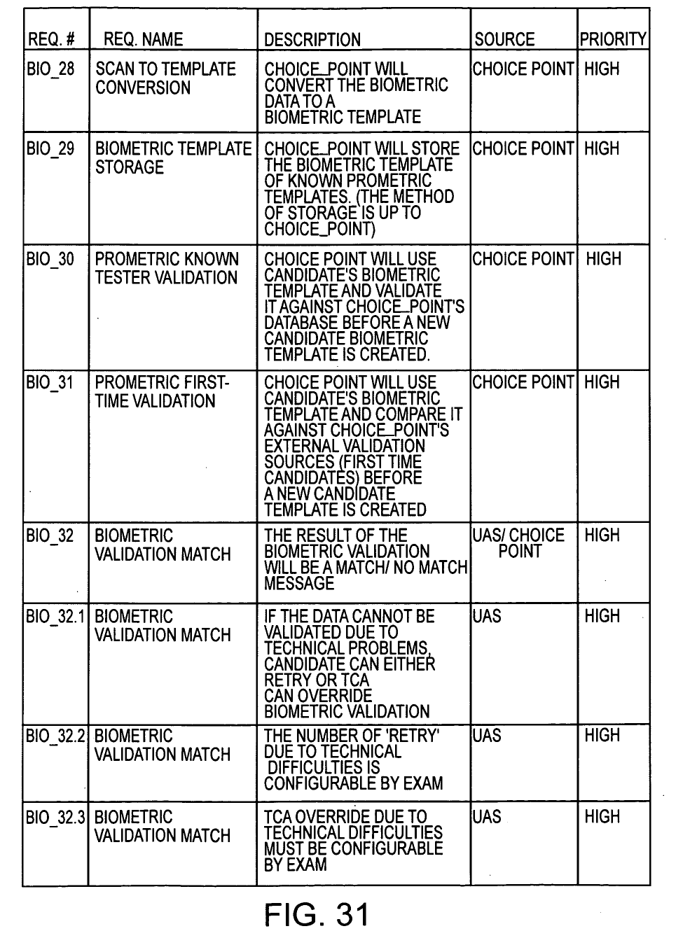

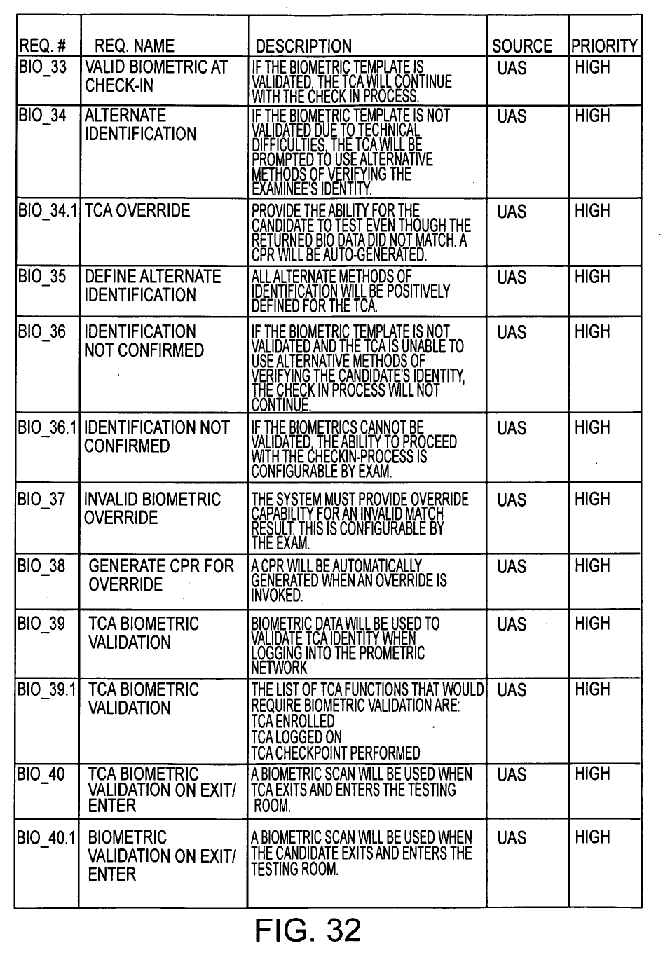

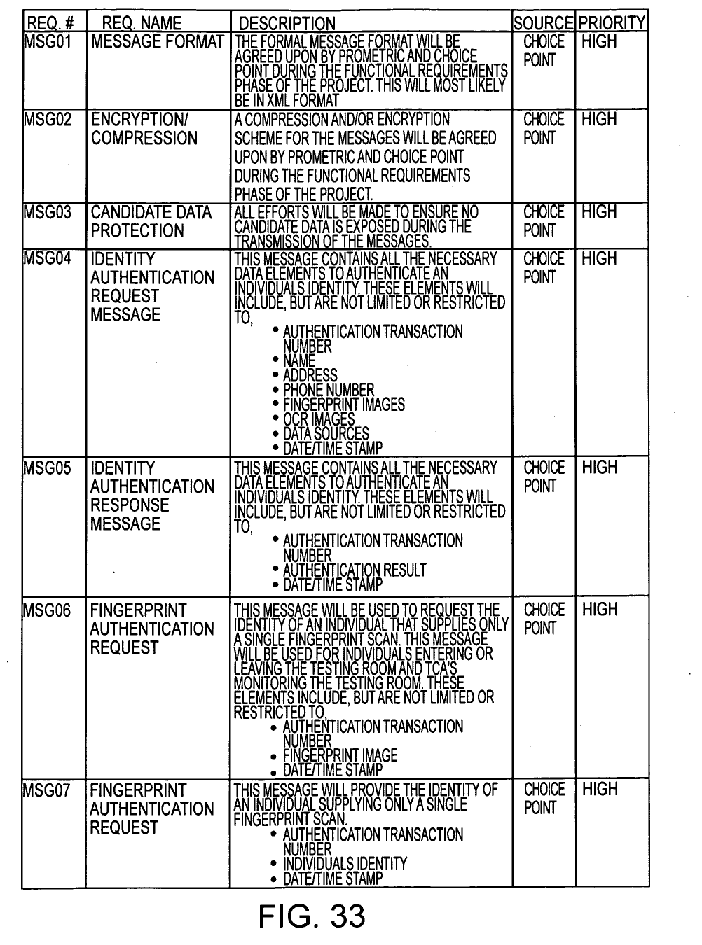

FIGS. 31 through 33 depict various system requirements according to the preferred embodiment of the present invention.

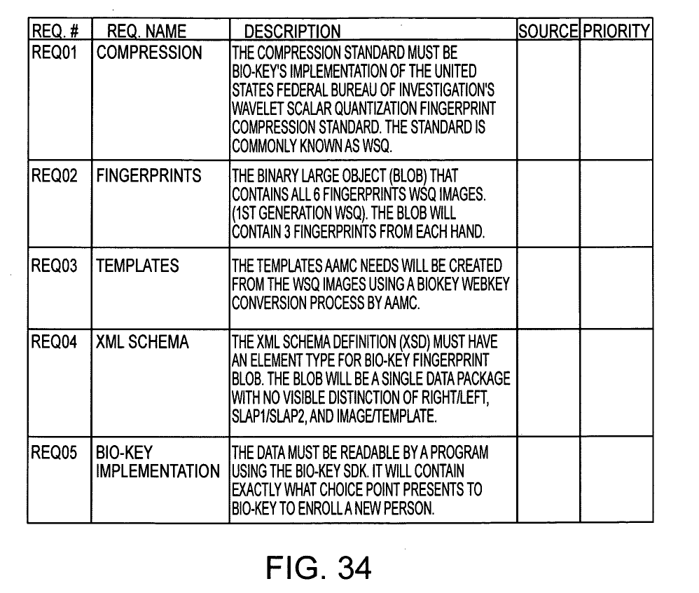

FIG. 34 depicts data formats according to one embodiment of the present invention.

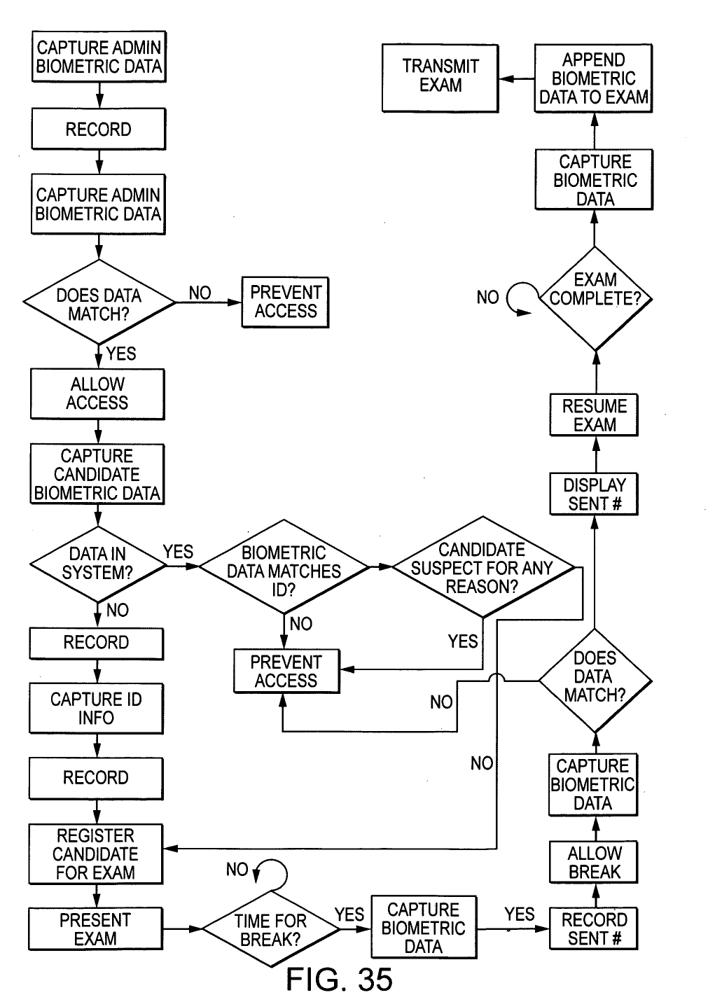

FIG. 35 shows a flow chart of identity management using biometric data according to one advantageous embodiment of the present invention. As shown, biometric data is captured from a test center administrator and the biometric data is recorded at a first time. At a second time, biometric data is captured from a test center administrator, which is compared to biometric data stored in a database. If it is determined that the data does not match data stored in the database the test center administrator is prevented from accessing the testing system. If it is determined that the data does match data stored in the database, the identity of the test center administrator is confirmed and the administrator is permitted access to the testing system.

The test center administrator then captures biometric data from at least one examination candidate. The biometric data is then compared, and if it is determined that the biometric data is not in the system, the test center administrator will enter the candidate's information into the system according to the steps described below.

If it is determined that the biometric data matches data stored in the database the test center administrator will compare identification information provided by the examination candidate with identification information associated with the biometric data stored in the database to determine whether the information match. If the identification information does not match, the examination candidate will be denied access to the examination. According to other embodiments of the present invention, secondary identification information is provided for comparison.

If the identification matches, it is then determined whether the candidate should be prevented access for any other reason, such as, for example, it is determined the candidate is not qualified to take the examination, the candidate has taken the examination a certain number of times, the candidate has taken the examination a certain amount of times within a certain period of time, etc. If it is determined that the candidate should not be excluded, the candidate is registered for the examination by the test center administrator.

If it is determined that biometric data corresponding to the examination candidate is not in the database, the biometric data is recording in the database. As well, identification information, such as, for example, a driver's license, passport, or other government identification, is captured and recorded. The identification information is associated with the candidate biometric data stored in the database. The examination candidate is then registered for the examination by the test center administrator.

The examination is then presented to the examination candidate. According to one embodiment of the present invention, biometric data or photo or video images may be captured at periodic intervals.

If the candidate wishes to take a break from the examination or if it is determined that it is time for a regularly scheduled break, biometric data is captured from the examination candidate to check-out the examination candidate for the break period. According to one embodiment of the present invention, the seat number of the examination candidate is recorded and associated with the biometric data captured from the examination candidate during the check-out process. The examination candidate is then allowed to take a break from the examination.

When the break has concluded, the examination candidate is checked-in from the break by capturing biometric data from the examination candidate. The biometric data is compared with biometric data captured during the check-out process. If it is determined that the biometric data does not match the data captured during the check-out process the candidate is prevented access to the remainder of the examination. If it is determined that the biometric data does match, the examination candidate is permitted to resume the examination. According to one embodiment of the present invention, the seat number associated with the examination candidate is displayed to prevent the examination candidate from resuming the examination in an incorrect seat.

When it is determined that the examination is complete, biometric data is captured from the examination candidate. According to one embodiment of the present invention, the biometric data captured from the examination candidate is appended to the examination. According to another embodiment, the examination with the appended data is transmitted for grading. One of skill in the art will recognize that the present invention may be used as a “cradle to the grave system” for tracking and ensuring that the examination candidate is the same individual at each examination. For example, the system may capture biometric data from an examination candidate when the individual sits for the pre-SAT for the first time. When the same individual returns to the sit for the SAT examination, biometric information can be captured from the examination candidate and compared to the previously captured biometric data to determine that the individual is the same person that sat for the pre-SAT examination. As well, the driver's license or other identification of the examination candidate can be compared against the previously stored information corresponding to the biometric data to ensure they match.

A school or university can ensure that the individual that registers for classes at the institution is the same individual that used a particular standardized test as part of an application for admission. This can be done by capturing biometric data from an individual that registers for classes at an institution and comparing the captured biometric data to biometric data appended to the standardize examination to determine that it is the same individual. This can be used to prevent students from fraudulent applying the examination results of another individual to their application for admission to a school or university. Further, many municipalities and countries throughout the world provide nothing more than a piece of paper without any picture identification as a means of formal identification. One of ordinary skill will recognize that the present invention may be used as another or additional means of identification.

Additionally, one of skill in the art will recognize that this procedure can be applied through the professional life of an individual. For example, the present invention may be used to capture biometric data from an examination candidate sitting for the MCAT examination. This data may then later be compared to biometric data captured from an individual sitting for the state medical boards to determine that it is the same individual. One of skill in the art can envision the present invention being applied such that one could determine that the individual that sat for the MCAT examination is the same individual presenting themselves at a hospital to begin their residency. Accordingly, the present invention optionally provides a multi-stage, multi-period procedure for identifying and/or authenticating individuals beyond the exam setting in a proactive and real-time manner that is not limited to the specific exam setting

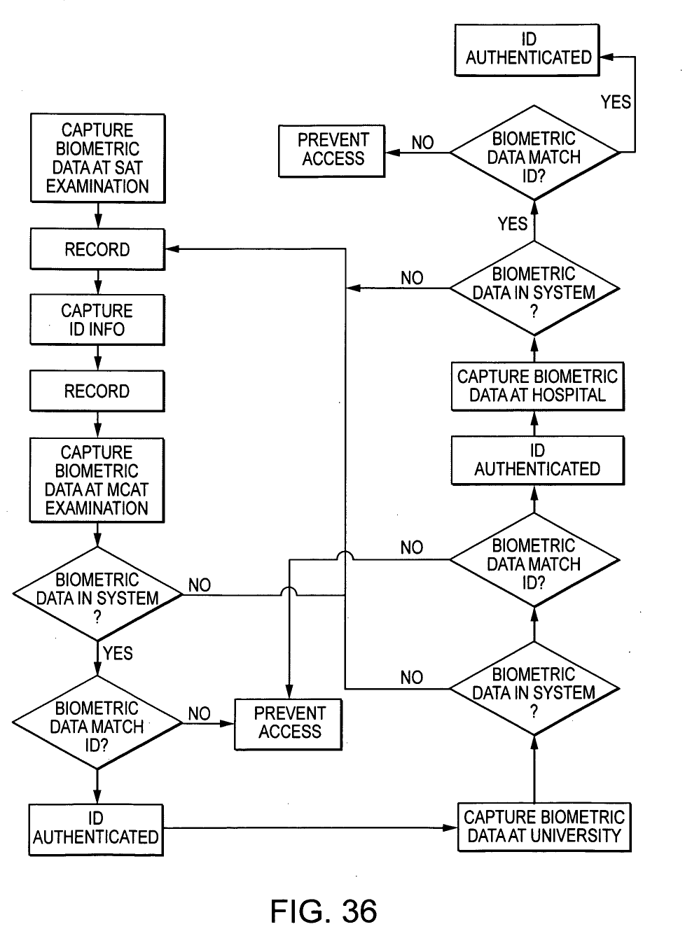

FIG. 36 depicts a flowchart describing one embodiment of the present invention that advantageously allows for a multi-stage, multi-period, and/or multi-episode procedure for identifying and/or authenticating test examination candidates and/or individuals. As shown, biometric data is captured from an examination candidate at a SAT examination, however, this could take place at any event where biometric data would be captured. For purposes of this example, the examination candidate is not in the database so identification information, such as a birth certificate, marriage license, social security card, drivers license, municipal, state or government ID is captured and stored in association with the captured biometric data. The dotted arrow depicts the passage of time, which could be any amount of time between events.

Next, biometric data is captured at an event at some later time. Here, the biometric data is captured at an MCAT examination taking place after the SAT examination. If the user is in the system, the captured biometric data will be compared against stored biometric data to determine whether there is a match. If there is no match, the individual has not previously been entered into the system and the procedure described above for entry into the database will be performed. If the captured data matches data stored in the database the identification information of the individual can be compared against the identification information associated with the biometric data in the database to authenticate the identity of the individual. If the identification is authenticated, the individual will be allowed to take the examination. Otherwise, the individual can be excluded from the examination.

The next steps demonstrate the same principles of the invention. At various events over varying periods of time, the identity of an individual can be authenticated by capturing biometric data from an individual, comparing the captured biometric data with data stored in a database to determine whether a match exists. If a match exists, the identification information of the individual can be compared against the identification information associated with the biometric data stored in the database to identify the individual.

While the FIG. 35 provides examples with respect to examinations and universities, one of ordinary skill in the art will recognize the ability to apply the invention in any number of situations and circumstances. For purposes of example, the invention can be used to authenticate the identity of individuals entering secure facilities, such as embassies, or government buildings. As well, the invention may be applied to check identification when checking-in at an airport, when applying for a drivers license or purchasing a car. The invention may also be applied to determine age, for example, at a movie theater, casino or bar. As well, the present invention advantageously allows biometric data and identification data to be stored once and then used repeatedly thereafter for verification.

One of skill will also recognize that the present invention provides the ability to track repeated test takers. A growing demand for test preparation has led to the theft of test material by test takers repeatedly taking examinations for the sole purpose of memorizing test material. By capturing biometric data from examination candidates each time the individual appears to sit for an examination, a TCA can determine that the examination candidate has appeared an inordinate amount of times and thereby take measures to protect the examination content. As well, the present invention can be used to determine whether the examination candidate has appeared using another name or present different identification and a TCA can take similar measures to protect examination content.

According to one embodiment of the present invention, biometric and identification data is stored in a database in a central location. In other embodiments, biometric and identification data is stored in a distributed system for each system that captures data. In one advantageous embodiment, biometric and identification data is transmitted to, from and between either a central location or distributed network in a secure manner such as encryption.

Other embodiments, extensions, and modifications of the ideas presented above are comprehended and within the reach of one skilled in the art upon reviewing the present disclosure. Accordingly, the scope of the present invention in its various aspects should not be limited by the examples and embodiments presented above. The individual aspects of the present invention and the entirety of the invention should be regarded so as to allow for modifications and future developments within the scope of the present disclosure. The present invention is limited only by the claims that follow.

What is claimed is:

1. A method of managing examination candidate identities, comprising:
requiring an administrator to authenticate their identity;
capturing biometric data from at least one candidate;
comparing the biometric data captured from the at least one candidate with data stored in a database;
determining if the biometric data captured from the at least one candidate and the data stored in the database match;
determining if the candidate meets rules for the examination; and
preventing the candidate from sitting for the examination if the candidate fails to meet the rules for the examination.

2. The method of claim 1, wherein the biometric data is at least one of a fingerprint, a thumbprint, a palm print, facial recognition data, retinal data and DNA.

3. The method of claim 2, wherein at least two types of biometric data are captured.

4. The method of claim 3, wherein at least second type of biometric data is compared if another type of biometric data is not accepted or not found in the database.

5 . The method of claim 1 further comprising:
capturing identification information from the at least one candidate.

6. The method of claim 5, wherein the capturing of identification information is performed if the captured biometric data is not accepted.

7. The method of claim 1, wherein the data stored in the database is at least one of a fingerprint, a thumbprint, a palm print, facial recognition data, retinal data and DNA.

8. The method of claim 1, wherein the capturing, comparing, determining and preventing is performed periodically during the examination.

9. The method of claim 1, wherein the biometric data captured from the at least one candidate is appended to the examination of the at least one candidate.

10. The method of claim 9 wherein the appended data is used for at least one of comparison with later captured biometric data, for validation of examination candidate identity, and for validation that another examination was taken by the same examination candidate.

11. The method of claim 1, further comprising:
capturing identification information from at least one candidate.

12. The method of claim 11, wherein identification information includes at least one of a driver's license, state issued identification card, national identification card, birth certificate, social security card, and marriage license.

13. The method of claim 12, wherein the identification information is appended to the examination of the at least one candidate.

14. The method of claim 1, further comprising:
a first capturing of biometric data from at least one candidate before allowing the at least one candidate to take a break during the examination;
a second capturing biometric data from at least one candidate before allowing the at least one candidate to resume taking the examination;
comparing the biometric data from the first and second capturing; and
determining if the biometric data from the first and second capturing match.

15. The method of claim 14 further comprising:
Storing the seat number of the at least one candidate before allowing the at least one candidate to take a break from the examination; and
Displaying the stored seat number if it is determined the data from the first and second capturing match.

16. The method of claim 1, further comprising:
capturing at least one image of the examination candidate periodically during the examination.

17. The method of claim 16, wherein the at least one image is appended to the examination.

18. The method of claim 1, further comprising:
allowing the at least one examination candidate to begin a break from the examination by capturing biometric data; and
allowing the at least one examination candidate to resume the examination after a break by capturing biometric data.

19. The method of claim 18, further comprising:
measuring the time between the beginning of a break and the resumption of the examination for the at least one candidate; and
appending the time to the examination of the at least one candidate.

20. The method of claim 19, further comprising:
capturing biometric data from the at least one candidate at a break location.

21. The method of claim 20, wherein the break location is at least one of a break room, a lounge, a restroom, a cafeteria, and a smoking area.

22. The method of claim 1, further comprising:
delivering the examination to the at least one candidate if the at least one candidate meets the criteria set forth in the determining steps.

23. The method of claim 1, further comprising:
providing an administrator a warning at regularly determined intervals,
the warning providing an indication for the administrator to perform a prescribed duty;
capturing biometric data from the administrator at the beginning of each prescribed duty; and
capturing biometric data from the administrator at the end of each prescribed duty.

24. The method of claim 1, further comprising:
capturing biometric data from at least one administrator;
comparing the biometric data captured from the at least one administrator with data stored in a database;
determining if the biometric data captured from the at least one administrator and the data stored in the database match.

25. The method of claim 24, wherein the requiring occurs before the capturing of the biometric data from at least one candidate.

26. A method of managing examination candidate identities, comprising:
capturing biometric data from at least one candidate;
transferring the biometric data to a database;
storing the biometric data in the database;
appending the biometric data from the at least one candidate to the examination of the at least one candidate;
capturing biometric data from an individual;
comparing the appended biometric data with the biometric data captured from the individual; and
determining if the appended biometric data and the biometric data captured from the individual match.

27. The method of claim 26, wherein the transferring is via the Internet.

28. A method of examination management, comprising:
capturing biometric data from at least one test center administrator;
storing biometric data from the at least one test center administrator in a database;
allowing a test center administrator to access a network by
capturing biometric data from the test administrator, and
comparing the biometric data captured from the test center administrator with data stored in the database;
registering at least one examination candidate by
determining if at least one examination candidate is present on a test roster,
selecting at the least one examination candidate from the roster,
capturing biometric from at least one examination candidate,
comparing the biometric data from the at least one examination candidate with data stored in the database, and
determining that the data captured from the at least one examination candidate and the data stored in the database match;
initiating the examination by
capturing biometric data from the at least one examination candidate,
comparing the biometric data from the at least one examination candidate with the data captured during the registering, and
determining that the data captured from the at least one examination candidate and the data captured during the registering match; and
terminating the examination by
capturing biometric data from the at least one examination candidate;
comparing the biometric data captured from the at least one examination candidate with the data capturing during the registering and initiating, and
determining that the data captured from the at least one examination candidate and the data captured during the registering and the initiating match.

29. A method of managing, identifying and/or authenticating individuals over time, comprising:
capturing biometric data from an individual at a first time;
capturing identification information from the individual at the first time;
storing the biometric data and identification information;
capturing biometric data from an individual at a second time;
comparing the biometric data captured at the second time with data stored in a database;
determining whether the biometric data captured at the second time and the data stored in the database match; and
authenticating the individual.

30. A system for managing examination candidate identities, comprising:
at least one biometric data capture device;
a computer processor in operable data communication with the at least one biometric data capture device; and
a database in operable data communication with the computer processor,
the database containing biometric data and identification information associated with the biometric data,
wherein the computer processor performs at least one of comparing biometric data from the biometric data capture device with biometric data stored in the database, displaying identification information associated with biometric data stored in the database, determining whether an examination candidate is qualified to take an examination, registering a an examination candidate from an exam, presenting an examination to a candidate, determining whether a break from an examination should occur, appending biometric data to an examination and transmitting an examination.
